(19) United States
(12) Patent Application Publication
(10) Pub. No.: US 2025/0014816 A1
(43) Pub. Date: Jan. 9, 2025

(54) METHOD FOR MANUFACTURING ELECTRONIC COMPONENT

(71) Applicant: ROHM CO., LTD., Kyoto-shi (JP)

(72) Inventor: Ryuya AOKI, Kyoto-shi (JP)

(21) Appl. No.: 18/891,266

(22) Filed: Sep. 20, 2024

Related U.S. Application Data
(63) Continuation of application No. PCT/JP2023/008602, filed on Mar. 7, 2023.

(30) Foreign Application Priority Data
Mar. 22, 2022 (JP) 2022-045199

(51) Int. Cl. H01F 41/06; H01F 41/12

(52) U.S. Cl. CPC H01F 41/06; H01F 41/12

(57) ABSTRACT

A method for manufacturing an electronic component includes a substrate preparation process including preparing an insulative substrate, an insulation layer formation process including forming an insulation layer on the substrate, a penetration process including forming a through-hole penetrating through the insulation layer, and a wiring process forming a through-wiring in the through-hole. The through-wiring constitutes at least a part of a coil unit wound in a solenoid form. The method may further include, before the insulation layer formation process, a first metal layer formation process including forming a first metal layer on the substrate. The through-wiring is continuous with the first metal layer, and the coil unit includes the first metal layer.

### TECHNICAL FIELD

The present disclosure relates to a manufacturing method of an electronic component.

### BACKGROUND ART

Various electronic components are mounted in an electric appliance. An example of such electronic component is an inductor. JP-A-2002-75739 discloses an example of the existing inductor. The inductor according to JP-A-2002-75739 includes a planarly wound copper coil.

### BRIEF DESCRIPTION OF THE DRAWINGS

FIG. 1 is a perspective view showing an electronic component according to a first embodiment.

FIG. 2 is a perspective view showing the electronic component of FIG. 1, in which a substrate, a coating film, and a sealing member are indicated by imaginary lines.

FIG. 3 is a perspective view showing a coil unit and a pair of connection wirings, in the electronic component according to the first embodiment.

FIG. 4 is an exploded perspective view showing the coil unit and the pair of connection wirings of FIG. 3.

FIG. 5 is a plan view showing the electronic component according to the first embodiment, from which the substrate and the coating film are excluded.

FIG. 6 is a bottom view showing the electronic component according to the first embodiment.

FIG. 7 is a front view showing the electronic component according to the first embodiment.

FIG. 8 is a left side view showing the electronic component according to the first embodiment.

FIG. 9 is a right side view showing the electronic component according to the first embodiment.

FIG. 10 is a cross-sectional view taken along a line X-X in FIG. 5.

FIG. 11 is a cross-sectional view taken along a line XI-XI in FIG. 5.

FIG. 12 is a cross-sectional view showing a process in a manufacturing method of the electronic component according to the first embodiment.

FIG. 13 is a cross-sectional view showing another process in the manufacturing method of the electronic component according to the first embodiment.

FIG. 14 is a plan view showing another process in the manufacturing method of the electronic component according to the first embodiment.

FIG. 15 is a cross-sectional view showing another process in the manufacturing method of the electronic component according to the first embodiment.

FIG. 16 is a cross-sectional view showing another process in the manufacturing method of the electronic component according to the first embodiment.

FIG. 17 is a cross-sectional view showing another process in the manufacturing method of the electronic component according to the first embodiment.

FIG. 18 is a cross-sectional view showing another process in the manufacturing method of the electronic component according to the first embodiment.

FIG. 19 is a plan view showing another process in the manufacturing method of the electronic component according to the first embodiment.

FIG. 20 is a cross-sectional view showing another process in the manufacturing method of the electronic component according to the first embodiment.

FIG. 21 is a cross-sectional view showing another process in the manufacturing method of the electronic component according to the first embodiment.

FIG. 22 is a plan view showing another process in the manufacturing method of the electronic component according to the first embodiment.

FIG. 23 is a cross-sectional view showing another process in the manufacturing method of the electronic component according to the first embodiment.

FIG. 24 is a cross-sectional view showing another process in the manufacturing method of the electronic component according to the first embodiment.

FIG. 25 is a plan view showing another process in the manufacturing method of the electronic component according to the first embodiment.

FIG. 26 is a cross-sectional view showing another process in the manufacturing method of the electronic component according to the first embodiment.

FIG. 27 is a cross-sectional view showing another process in the manufacturing method of the electronic component according to the first embodiment.

FIG. 28 is a cross-sectional view showing another process in the manufacturing method of the electronic component according to the first embodiment.

FIG. 29 is a cross-sectional view showing another process in the manufacturing method of the electronic component according to the first embodiment.

FIG. 30 is a cross-sectional view showing another process in the manufacturing method of the electronic component according to the first embodiment.

FIG. 31 is a perspective view showing an electronic component according to a second embodiment, in which the substrate, the coating film, and the sealing member are indicated by imaginary lines.

FIG. 32 is a plan view showing the electronic component according to the second embodiment, from which the substrate and the coating film are excluded.

FIG. 33 is a bottom view showing the electronic component according to the second embodiment.

FIG. 34 is a cross-sectional view taken along a line XXXIV-XXXIV in FIG. 32.

FIG. 35 is a cross-sectional view showing a process in the manufacturing method of the electronic component according to the second embodiment.

FIG. 36 is a cross-sectional view showing another process in the manufacturing method of the electronic component according to the second embodiment.

FIG. 37 is a cross-sectional view showing another process the manufacturing method of the electronic component according to the second embodiment.

FIG. 38 is a cross-sectional view showing another process in the manufacturing method of the electronic component according to the second embodiment.

FIG. 39 is a cross-sectional view showing another process in the manufacturing method of the electronic component according to the second embodiment.

FIG. 40 is a cross-sectional view showing another process in the manufacturing method of the electronic component according to the second embodiment.

FIG. 41 is a cross-sectional view showing another process in the manufacturing method of electronic component according to the second embodiment.

FIG. 42 is a cross-sectional view showing another process in the manufacturing method of the electronic component according to the second embodiment.

FIG. 43 is a cross-sectional view showing another process in the manufacturing method of the electronic component according to the second embodiment.

FIG. 44 is a cross-sectional view showing another process in the manufacturing method of the electronic component according to the second embodiment.

FIG. 45 is a cross-sectional view showing another process in the manufacturing method of the electronic component according to the second embodiment.

FIG. 46 is a perspective view showing an electronic component according to a third embodiment, in which the substrate, the coating film, and the sealing member are indicated by imaginary lines.

FIG. 47 is an exploded perspective view showing the coil unit and the pair of connection wirings of the electronic component according to the third embodiment.

FIG. 48 is a plan view showing the electronic component according to the third embodiment, from which the substrate and the coating film are excluded.

FIG. 49 is a bottom view showing the electronic component according to the third embodiment.

FIG. 50 is a perspective view showing an electronic component according to a fourth embodiment, in which the substrate, the coating film, and the sealing member are indicated by imaginary lines.

FIG. 51 is an exploded perspective view showing the coil unit and the pair of connection wirings of the electronic component according to the fourth embodiment.

FIG. 52 is a plan view showing the electronic component according to the fourth embodiment, from which the substrate and the coating film are excluded.

FIG. 53 is a bottom view showing the electronic component according to the fourth embodiment.

### DETAILED DESCRIPTION OF EMBODIMENTS

Hereafter, embodiments of an electronic component according to the present disclosure will be described, with reference to the drawings. In the drawings, the same or similar elements will be given the same numeral, and the description of such elements will not be repeated. The terms “first”, “second”, “third”, and so forth used in the present disclosure merely serve as a label, and are not necessarily intended to specify an order with respect to the objects accompanied with these terms.

In the description of the present disclosure, the expression “An object A is formed in an object B”, and “An object A is formed on an object B” imply the situation where, unless otherwise specifically noted, “the object A is formed directly in or on the object B”, and “the object A is formed in or on the object B, with something else interposed between the object A and the object B”. Likewise, the expression “An object A is arranged in an object B”, and “An object A is arranged on an object B” imply the situation where, unless otherwise specifically noted, “the object A is arranged directly in or on the object B”, and “the object A is arranged in or on the object B, with something else interposed between the object A and the object B”. Further, the expression “An object A is located on an object B” implies the situation where, unless otherwise specifically noted, “the object A is located on the object B, in contact with the object B”, and “the object A is located on the object B, with something else interposed between the object A and the object B”. Further, the expression “An object A is overlapping with an object B when viewed in a certain direction” implies the situation where, unless otherwise specifically noted, “the object A is overlapping with the entirety of the object B”, and “the object A is overlapping with a part of the object B”.

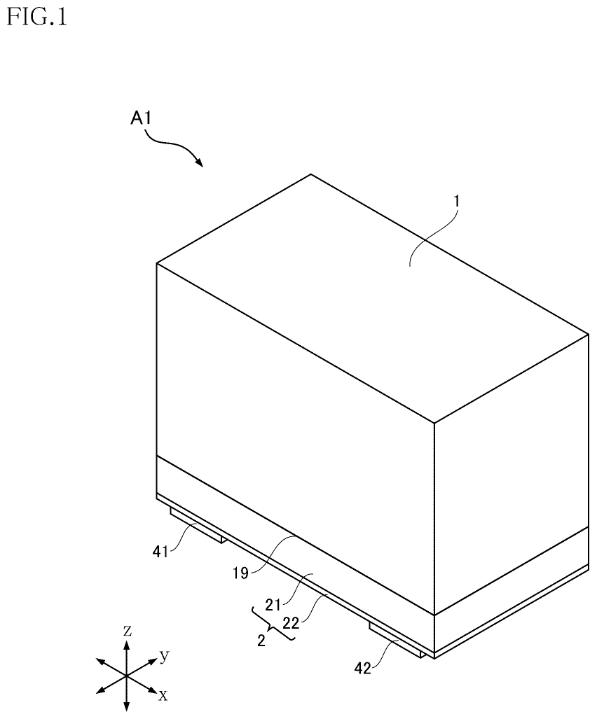

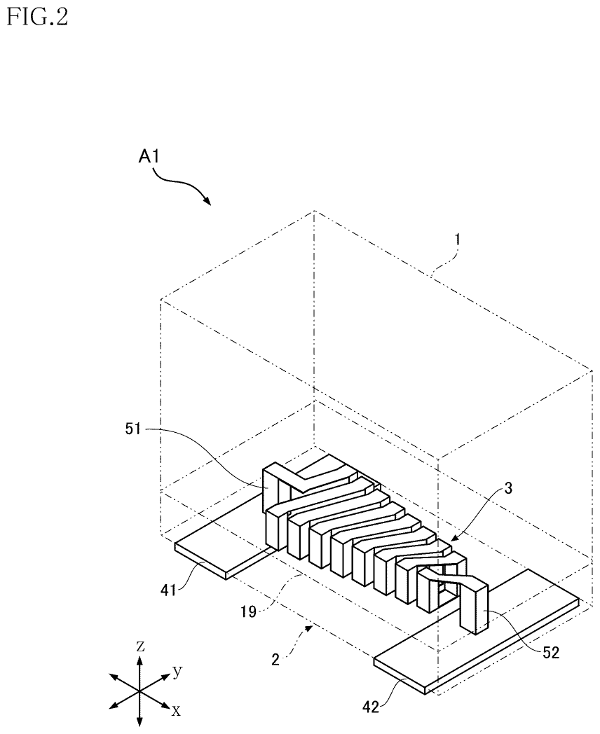

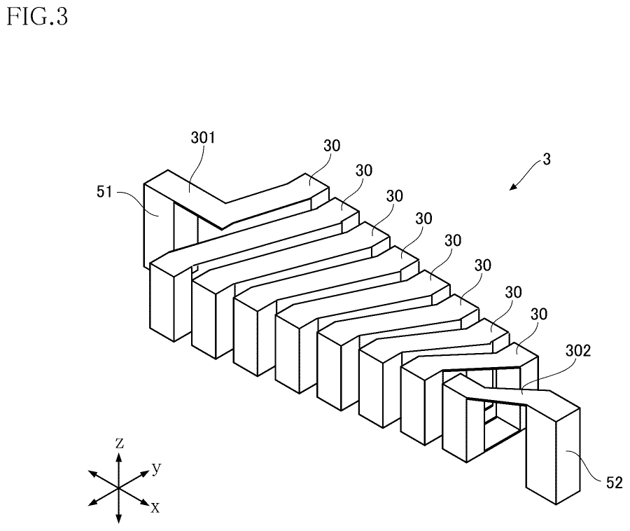

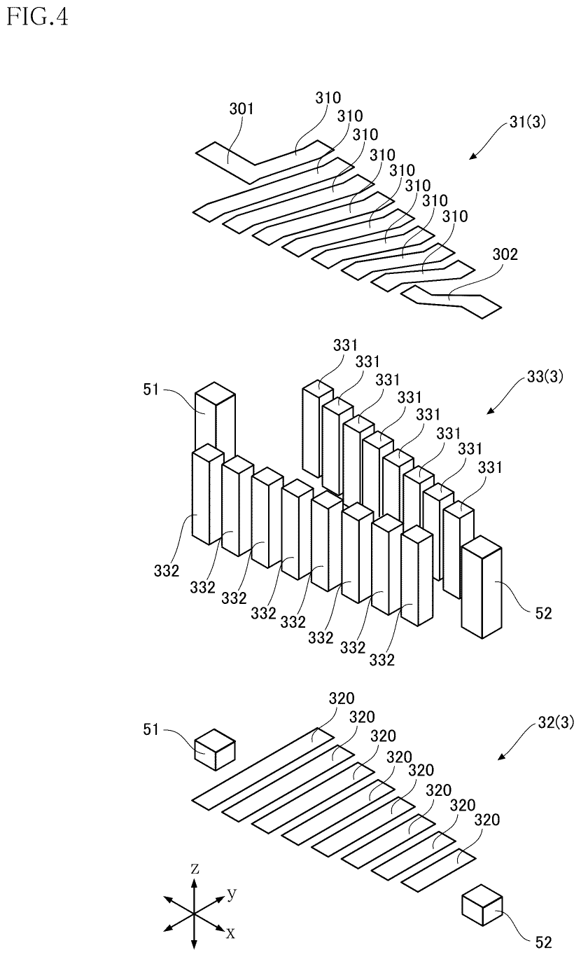

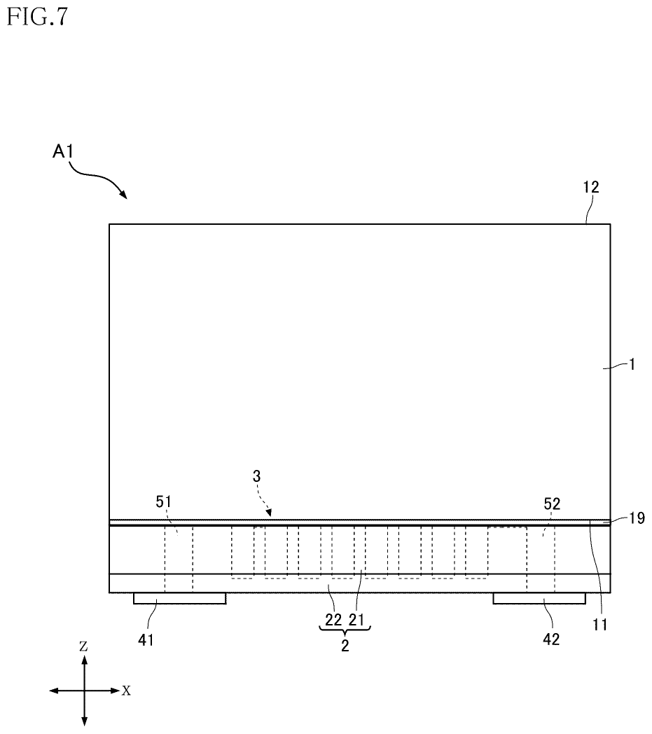

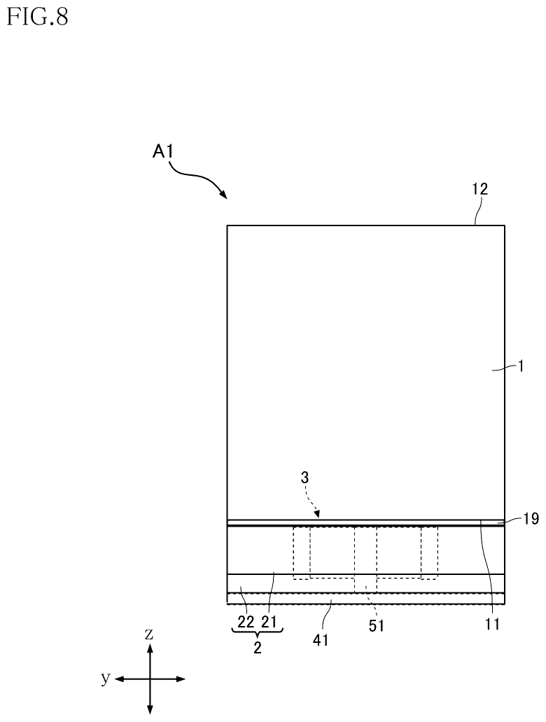

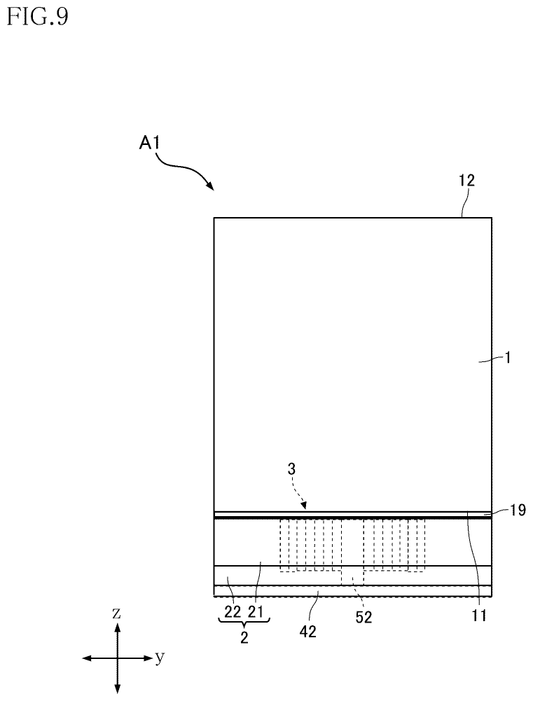

FIG. 1 to FIG. 11 illustrate an electronic component A1 according to a first embodiment. The electronic component A1 includes a substrate 1, a coating film 19, a sealing member 2, a coil unit 3, a pair of external electrodes 41 and 42, and a pair of connection wirings 51 and 52. In this embodiment, the electronic component A1 is an inductor. The electronic component A1 is of a surface-mounting type.

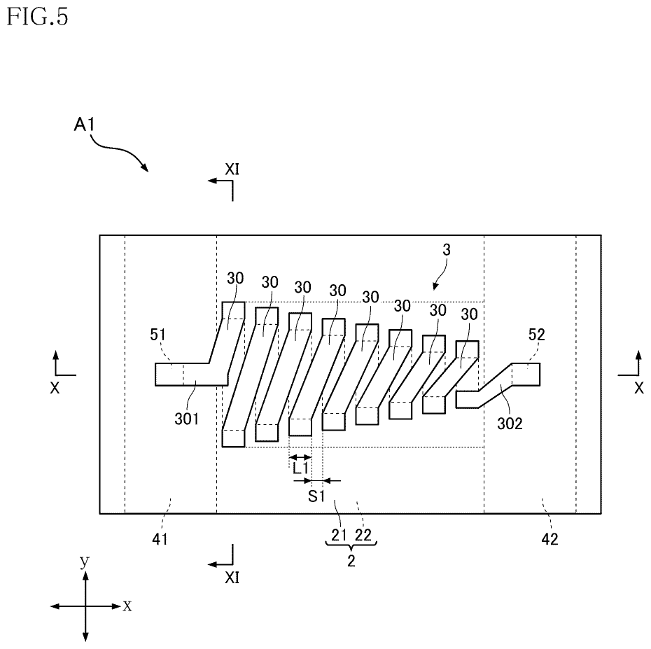

For the sake of convenience in description, the thickness direction of the electronic component A1 will be referred to as “z-direction”. In the following description, one side in the z-direction may be referred to as upper side, and the other side as lower side. The expressions “upper”, “lower”, “upward”, “downward”, “upper face”, “lower face”, and so forth indicate relative positional relations between the components with respect to the z-direction, and are not necessarily intended to define the relation with the gravity direction. In addition, the term “in a plan view” refers to a view in the z-direction. A direction orthogonal to the z-direction will be defined as “x-direction”. The x-direction corresponds to the left-right direction in the plan view of the electronic component A1 (see FIG. 5). A direction orthogonal to the z-direction and the x-direction will be defined as “y-direction”. The y-direction corresponds to the up-down direction in the plan view of the electronic component A1 (see FIG. 5).

The substrate 1 supports the sealing member 2 and the coil unit 3. The substrate 1 is, for example, a semiconductor substrate. The materials of the semiconductor substrate include, for example, silicon (Si). Accordingly, the substrate 1 is, for example, a silicon substrate. The substrate 1 may be, instead of the semiconductor substrate, a glass substrate, or a ceramic substrate. The substrate 1 has a rectangular shape in a plan view. The size of the substrate 1 in the x-direction is, for example, between 0.1 mm and 3.0 mm, both ends inclusive, and the size of the substrate 1 in the y-direction is, for example, between 0.1 mm and 3.0 mm, both ends inclusive.

The substrate 1 includes a substrate main face 11 and a substrate back face 12. The substrate main face 11 and the substrate back face 12 are spaced from each other in the z-direction. The substrate main face 11 is oriented downward in the z-direction, and the substrate back face 12 is oriented upward in the z-direction. The substrate main face 11 is opposed to the sealing member 2. The substrate back face 12 is exposed to outside of the electronic component A1.

The coating film 19 covers the substrate main face 11 of the substrate 1. The materials of the coating film 19 include, for example, an insulative material. The insulative material may include, for example, silicon nitride (SiN). The coating film 19 may further include, for example, a capacitor of a metal-insulator-metal (MIM) structure, or an oxide film (e.g., silicon dioxide (SiO₂) film). When the coating film 19 includes the capacitor, the capacitor is electrically continuous with the coil unit 3, and constitutes the electronic component A1 as an LC composite device. Here, the electronic component A1 may be without the coating film 19, provided that there is no likelihood of electrical short circuit via the substrate 1.

The sealing member 2 is located on the substrate main face 11, via the coating film 19. The sealing member 2 has a rectangular shape in a plan view. The dimensions of the sealing member 2 in the x-direction and the y-direction are the same as the dimensions of the substrate 1 in the x-direction and the y-direction, respectively. The sealing member 2 covers the coil unit 3. The sealing member 2 includes an insulation layer 21 and a protective film 22.

The insulation layer 21 is formed on the coating film 19. The materials of the insulation layer 21 include, for example, a photosensitive resin. The insulation layer 21 is, for example, formed of a dry film resist. The dry film resist includes an epoxy resin, acting as a photosensitive resin. The size of the insulation layer 21 in the z-direction is, for example, between 20 μm and 45 μm, both ends inclusive.

The protective film 22 is formed on the insulation layer 21. The materials of the protective film 22 include an insulative material. The insulative material includes, for example, polyimide. The protective film 22 is located on the opposite side of the substrate 1 in the z-direction, across the insulation layer 21.

The coil unit 3 serves as the electrical functional core of the electronic component A1. The coil unit 3 is formed on the substrate 1, and covered with the sealing member 2. In this embodiment, as will be subsequently described in further detail, the coil unit 3 is wound in a solenoid form, and formed in a truncated conical shape.

The coil unit 3 includes a first metal layer 31, a second metal layer 32, and a through-wiring 33. In this embodiment, the first metal layer 31, the second metal layer 32, and the through-wiring 33 are each formed of copper or a copper-based alloy. The coil unit 3 may be formed of, instead of either the copper or the copper-based alloy, another metal material such as aluminum or an aluminum-based alloy, or silver or a silver-based alloy. For example, the first metal layer 31 may be formed of aluminum or an aluminum-based alloy.

The first metal layer 31 is formed on the protective film 22, and covered with the insulation layer 21. The thickness (size in the z-direction) of the first metal layer 31 is, for example, between 0.1 μm and 45 μm, both ends inclusive. The first metal layer 31 includes a plurality of belt-like portions 310. The plurality of belt-like portions 310 are spaced from each other. The plurality of belt-like portions 310 are located at the same position in the z-direction, and overlap with each other when viewed in the x-direction. The plurality of belt-like portions 310 each extend along a direction slightly inclined with respect to the y-direction, in a plan view. The plurality of belt-like portions 310 are parallel to each other, and aligned in the x-direction.

The second metal layer 32 is formed on the insulation layer 21, and covered with the protective film 22. The thickness (size in the z-direction) of the second metal layer 32 is, for example, between 0.1 μm to 45 μm, both ends inclusive. The second metal layer 32 includes a plurality of belt-like portions 320. The plurality of belt-like portions 320 are spaced from each other. The plurality of belt-like portions 320 are located at the same position in the z-direction, and overlap with each other when viewed in the x-direction. The plurality of belt-like portions 320 each extend along the y-direction, in a plan view. The plurality of belt-like portions 320 are parallel to each other, and aligned in the x-direction. Here, the plurality of belt-like portions 310 may each extend along the y-direction in a plan view, and the plurality of belt-like portions 320 may each extend along a direction slightly inclined with respect to the y-direction, in a plan view.

The through-wiring 33 is penetrating through the insulation layer 21 in the z-direction. The through-wiring 33 is in contact with the first metal layer 31 and the second metal layer 32, thus electrically connecting these metal layers. The thickness (size in the z-direction) of the through-wiring 33 depends on the thickness (size in the z-direction) of the insulation layer 21 and is, for example, between 20 μm and 45 μm, both ends inclusive, in this embodiment.

The through-wiring 33 includes a plurality of penetrating portions 331, and a plurality of penetrating portions 332. The plurality of penetrating portions 331 and the plurality of penetrating portions 332 are spaced from each other in the y-direction. The plurality of penetrating portions 331 are located so as to respectively correspond to the plurality of penetrating portions 332. The penetrating portions 331 and 332 constituting a pair overlap with each other, when viewed in the y-direction.

The plurality of penetrating portions 331 are aligned in a direction slightly inclined to one side in the y-direction, with respect to the x-direction. Accordingly, the plurality of penetrating portions 331 are slightly deviated from each other, when viewed in the x-direction. In the illustrated example, the plurality of penetrating portions 331 are aligned so as to be closer to the center of the insulation layer 21 in the y-direction, in the direction toward one end portion in the x-direction (e.g., right side in FIG. 5), when viewed in the x-direction.

The plurality of penetrating portions 332 are aligned in a direction slightly inclined to the other side in the y-direction, with respect to the x-direction. Accordingly, the plurality of penetrating portions 332 are slightly deviated from each other, when viewed in the x-direction. In the illustrated example, the plurality of penetrating portions 332 are aligned so as to be closer to the center of the insulation layer 21 in the y-direction, in the direction toward the one end portion in the x-direction (e.g., right side in FIG. 5), when viewed in the x-direction.

The coil unit 3 includes a plurality of loop portions 30, and a pair of terminal portions 301 and 302. The pair of terminal portions 301 and 302 are each electrically continuous with the plurality of loop portions 30.

The terminal portion 301 is continuous with the one of the plurality of loop portions 30, located closest to the other end portion in the x-direction. The terminal portion 302 is continuous with the one of the plurality of loop portions 30, located closest to the one end portion in the x-direction. As shown in FIG. 5, the pair of terminal portions 301 and 302 each have a belt-like shape, in a plan view. In the illustrated example, the terminal portion 301 extends along the x-direction. The terminal portion 302 extends along a direction slightly inclined to one side in the y-direction, with respect to the x-direction.

The plurality of loop portions 30 are aligned along the x-direction. The ones of the plurality of loop portions 30, located adjacent to each other in the x-direction, are continuous with each other. In this embodiment, the plurality of loop portions 30 are formed such that the size in the y-direction becomes smaller, in the direction toward the one side in the x-direction (right side in FIG. 5). To be more specific, the plurality of loop portions 30 are formed such that the length along the circumferential direction becomes shorter, in the direction toward the one side in the x-direction (right side in FIG. 5). In a plan view, the wiring width L1 (see FIG. 5) of each of the plurality of loop portions 30 is, for example, between 1 μm and 20 μm, both ends inclusive, and the clearance S1 (see FIG. 5) between the loop portions 30 adjacent to each other is, for example, between 1 μm and 20 μm, both ends inclusive.

Each of the loop portions 30 includes one each of the belt-like portion 310, the belt-like portion 320, and the pair of penetrating portions 331 and 332. In each of the loop portions 30, the penetrating portion 331 is connected to the belt-like portion 310 and the belt-like portion 320, of the corresponding loop portion 30. In each of the loop portions 30, the penetrating portion 332 is connected to the belt-like portion 320 of the corresponding loop portion 30, and to the belt-like portion 310 of the loop portion 30 adjacent to the corresponding loop portion 30, on the one side in the x-direction (right side in FIG. 5).

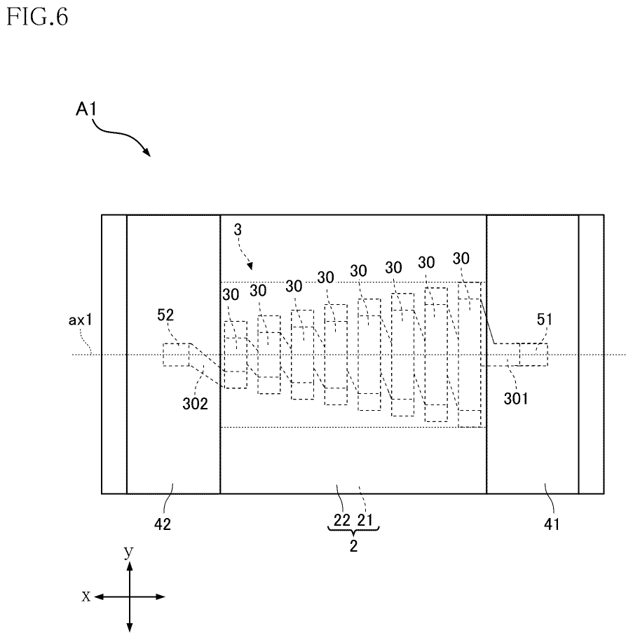

In this embodiment, the plurality of loop portions 30 are each wound by the wire about a winding axis, coinciding with a common axial line ax1 (see FIG. 6). The axial line ax1 (see FIG. 6) extends along the x-direction. Accordingly, with respect to the electronic component A1, the x-direction exemplifies the “first direction” in the present disclosure. Since the plurality of loop portions 30 are aligned in the x-direction, the axial line ax1 may be described as extending in the alignment direction of the plurality of loop portions 30. The axial lines, in other words the winding axes of the respective loop portions 30 coincide with each other, when viewed in the x-direction. In this embodiment, the winding axis of each of the loop portions 30 corresponds to a straight line passing through the center of a region defined by each of the loop portions 30, in a view in the x-direction. The loop portions 30 each have a rectangular ring shape centered by the axial line ax1, when viewed in the x-direction.

The plurality of loop portions 30 each include portions overlapping with the remaining loop portions 30, and portions deviated from the remaining loop portions 30, when viewed in the alignment direction (first direction) of the plurality of loop portions 30. In the illustrated example, the pairs of the belt-like portions 310 and 320 of the respective loop portions 30 overlap with each other when viewed in the x-direction, and the pairs of the penetrating portions 331 and 332 of the respective loop portions 30 are deviated from each other, when viewed in the x-direction.

The pair of external electrodes 41 and 42 are each electrically continuous with the coil unit 3. The external electrode 41 is electrically continuous with the terminal portion 301 of the coil unit 3, and the external electrode 42 is electrically continuous with the terminal portion 302 of the coil unit 3. The materials of the pair of external electrodes 41 and 42 include a conductive material. The type of the conductive material is not specifically limited, but may be, for example, copper or a copper-based alloy. The pair of external electrodes 41 and 42 are formed on the sealing member 2. The pair of external electrodes 41 and 42 each serve as a terminal for mounting the electronic component A1 on a circuit board of an electric appliance or the like.

The connection wiring 51 electrically connects the terminal portion 301 of the coil unit 3 and the external electrode 41. The connection wiring 52 electrically connects the terminal portion 302 of the coil unit 3 and the external electrode 42. The materials of the pair of connection wirings 51 and 52 include a conductive material. The type of the conductive material is not specifically limited, but may be, for example, copper or a copper-based alloy. The pair of connection wirings 51 and 52 are each formed so as to penetrate through the sealing member 2 (insulation layer 21 and protective film 22), in the z-direction. The pair of connection wirings 51 and 52 each have the same layer structure as the first metal layer 31, the second metal layer 32, and the through-wiring 33. Instead, the pair of connection wirings 51 and 52 may each be formed in a single pillar shape.

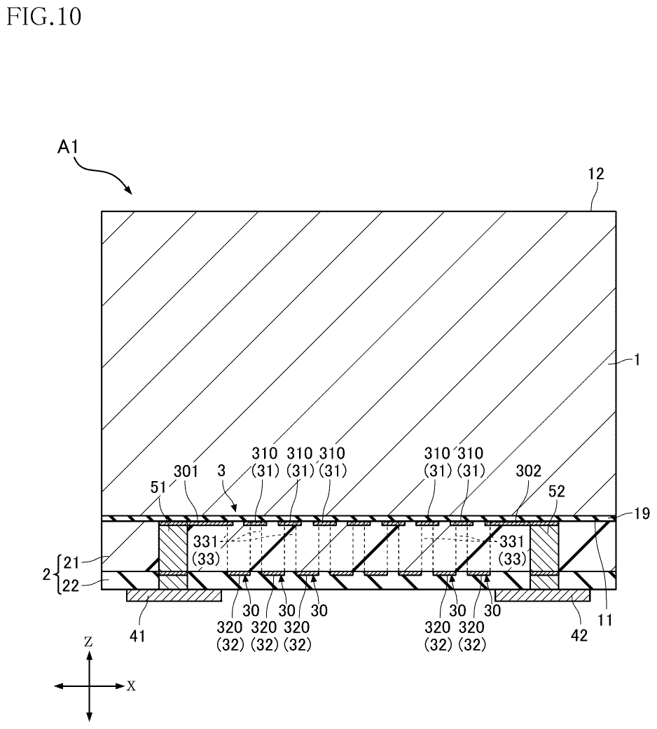

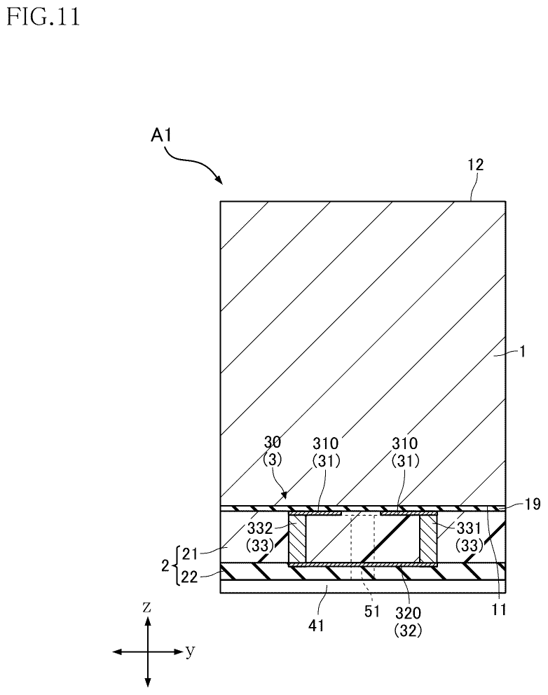

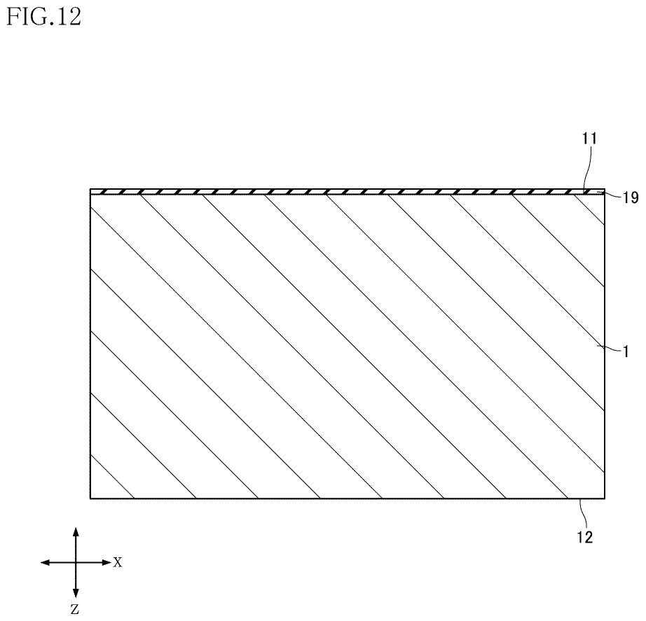

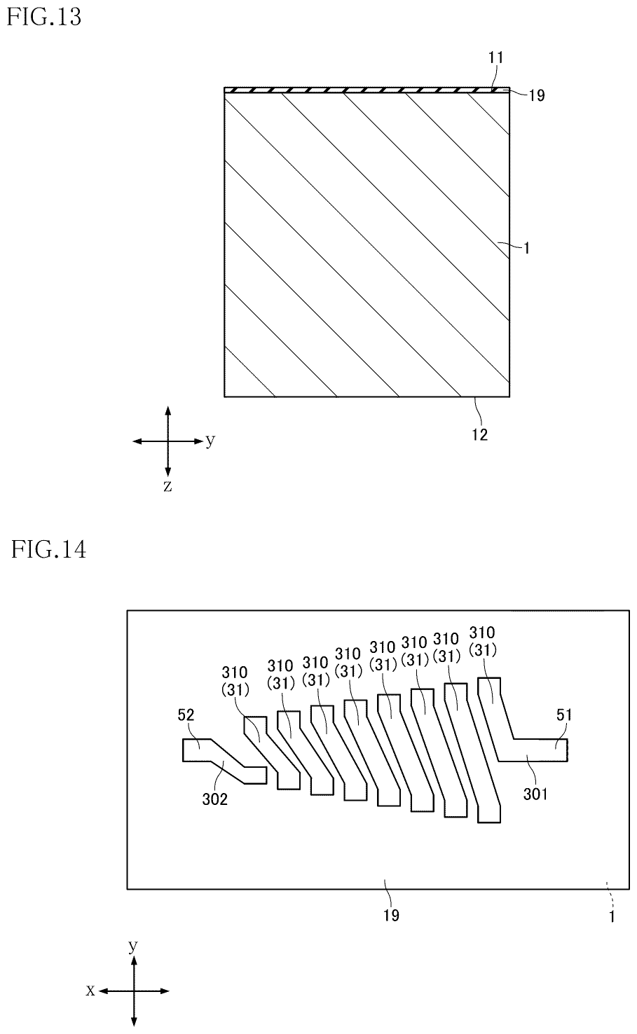

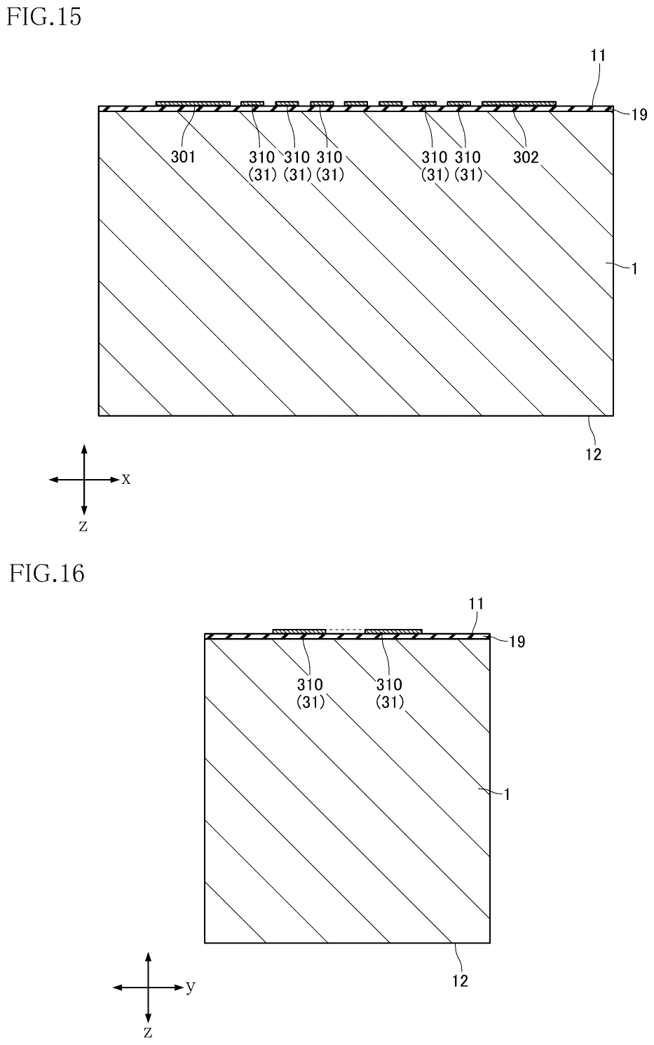

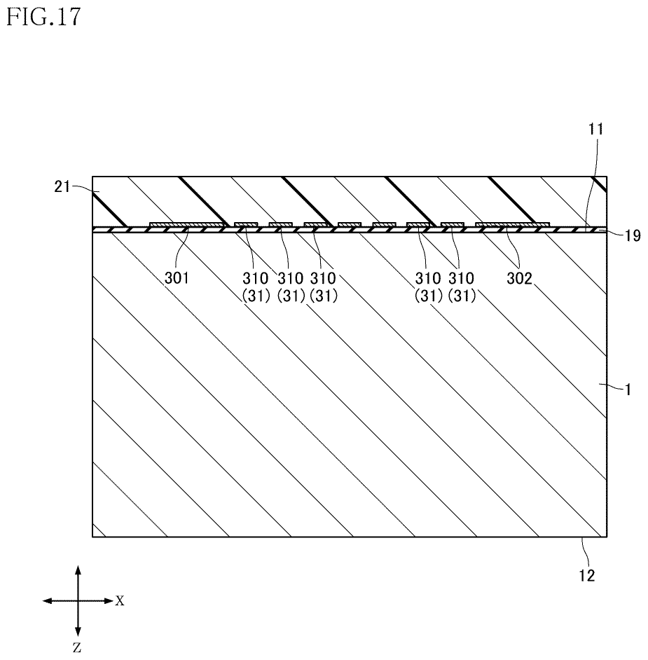

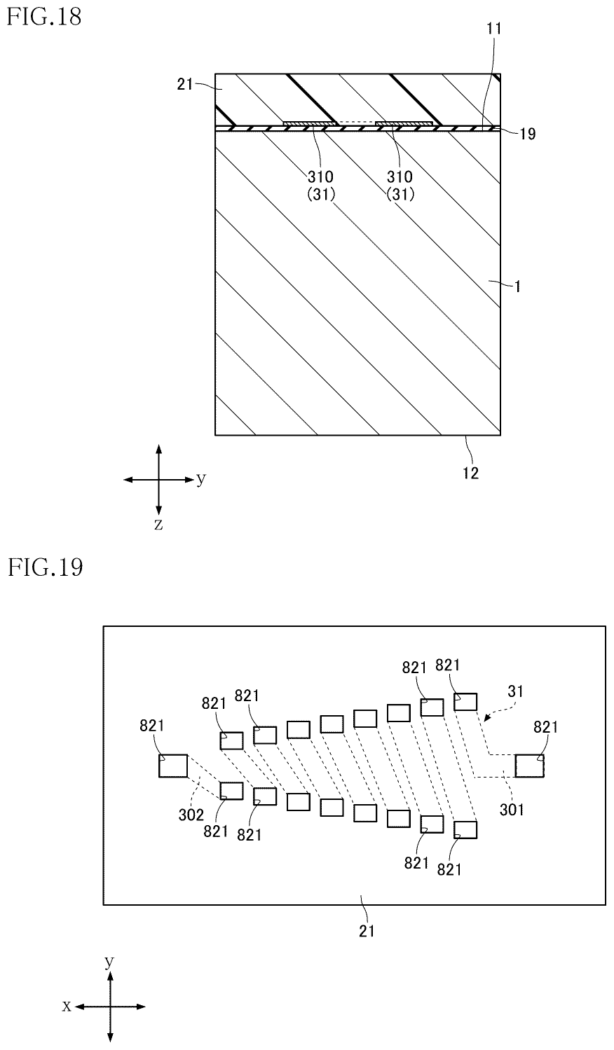

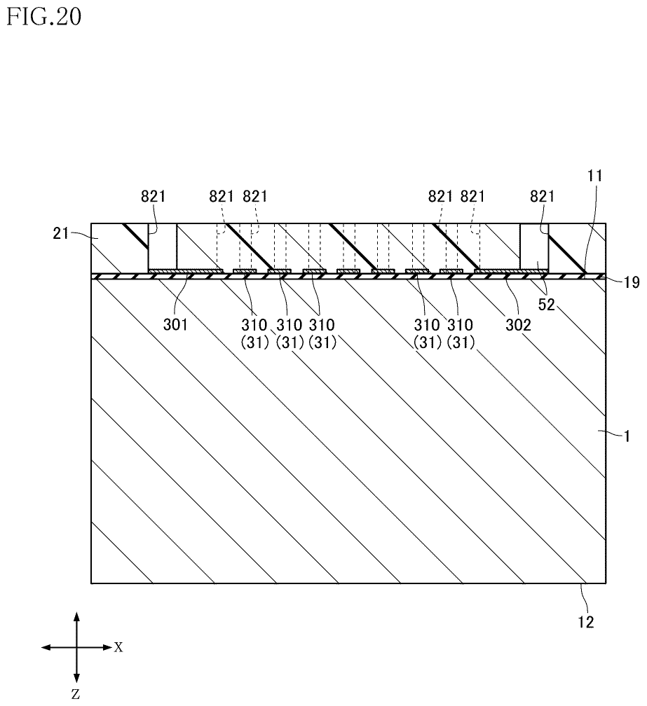

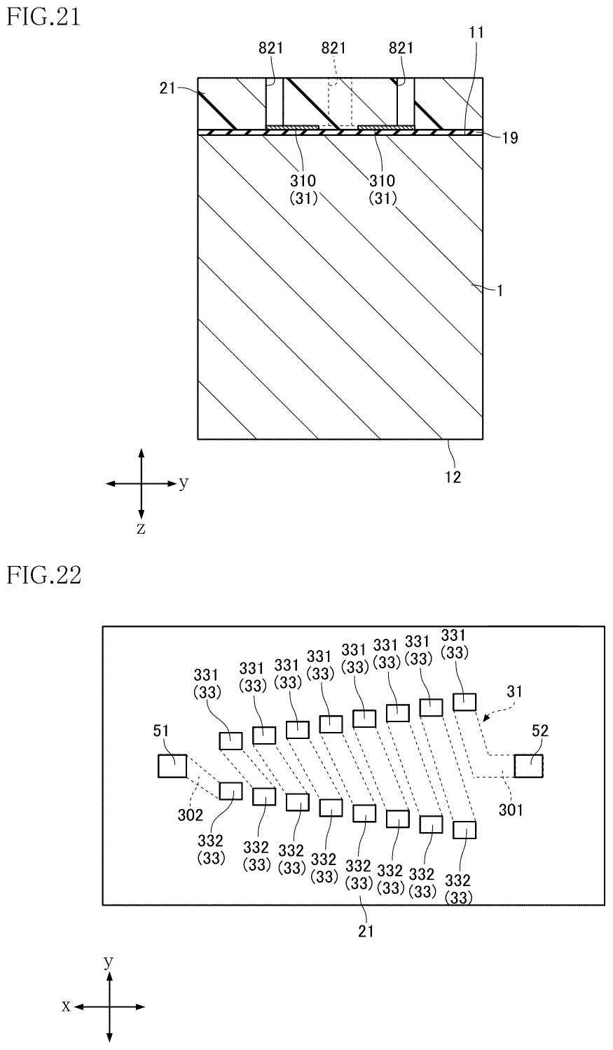

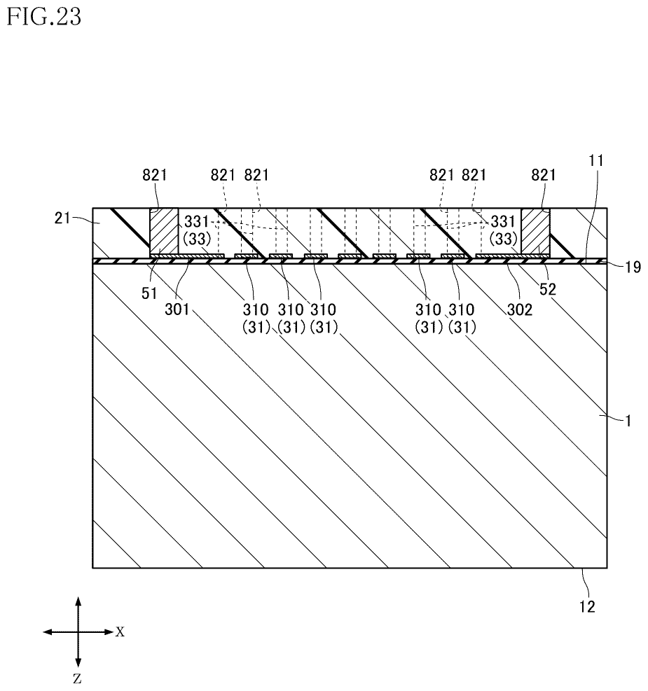

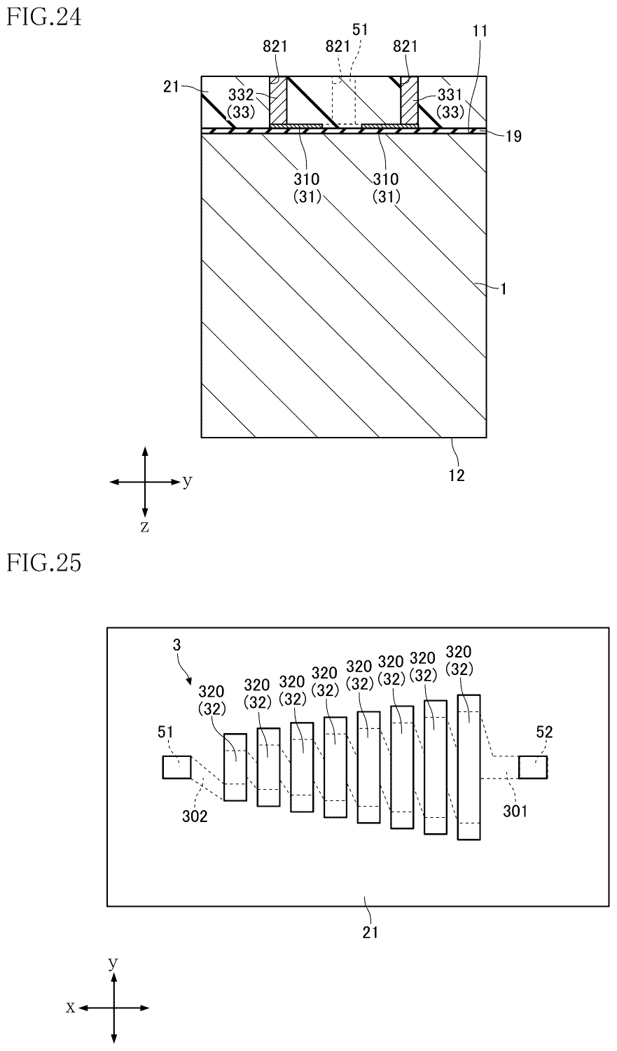

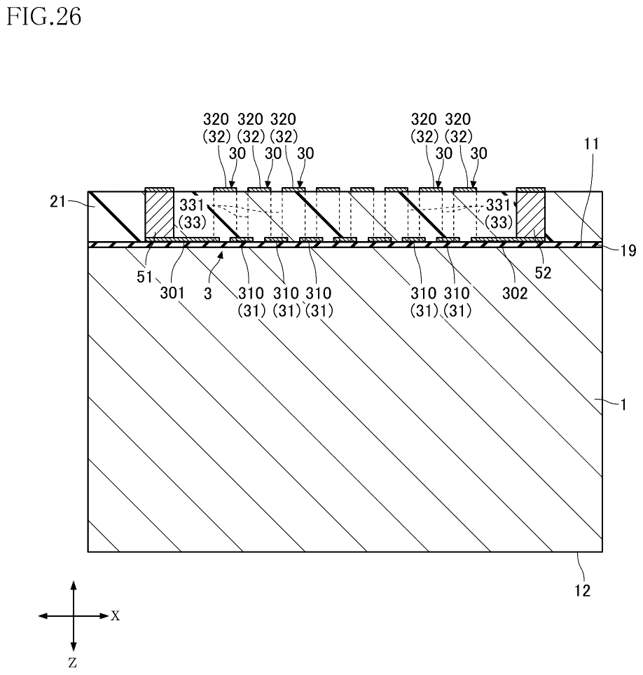

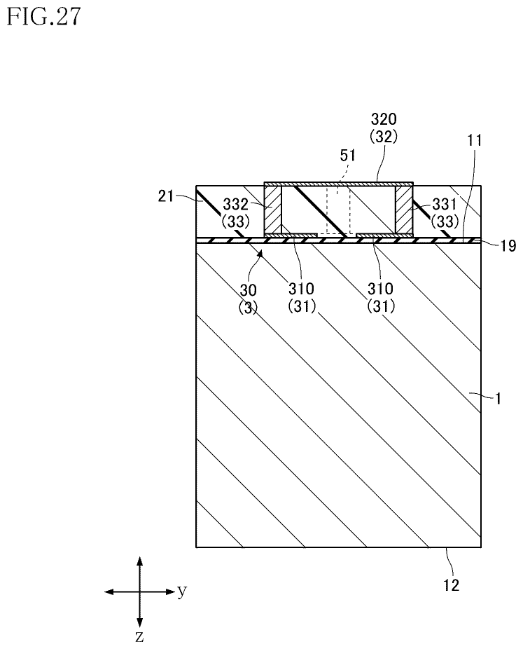

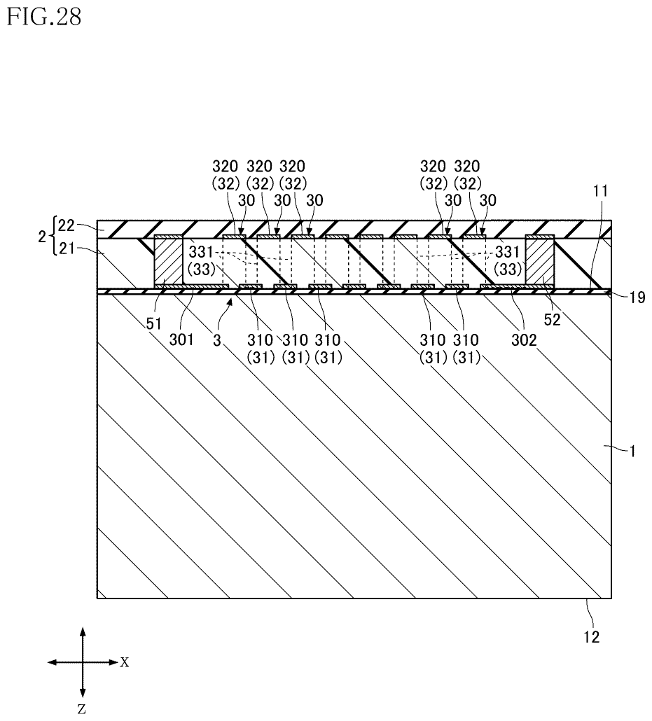

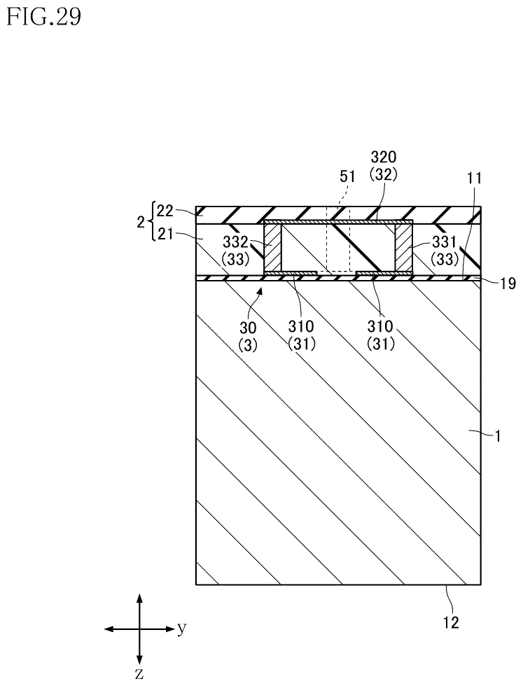

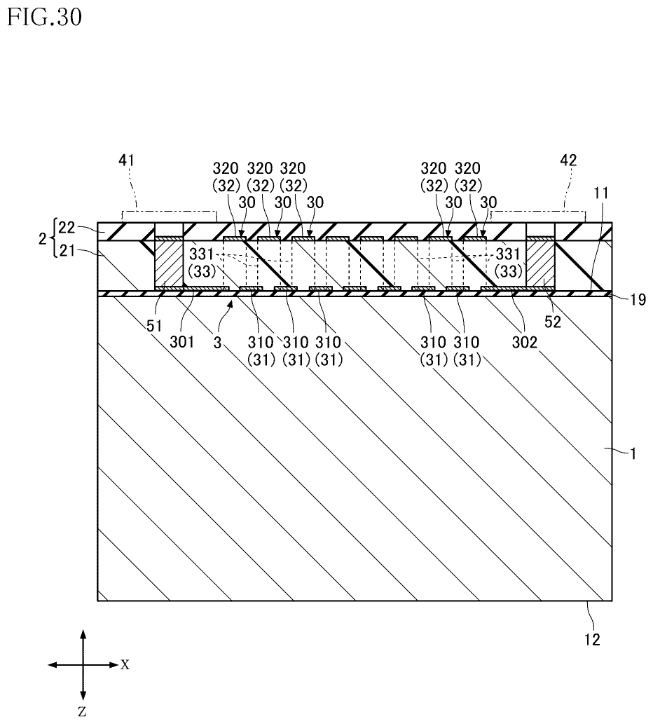

Hereunder, the manufacturing method of the electronic component A1 will be described, with reference to FIG. 12 to FIG. 30. FIG. 12, FIG. 15, FIG. 17, FIG. 20, FIG. 23, FIG. 26, FIG. 28, and FIG. 30 are cross-sectional views each showing a process in the manufacturing method of the electronic component A1, and each correspond to the cross-section of the electronic component A1 shown in FIG. 10. FIG. 13, FIG. 16, FIG. 18, FIG. 21, FIG. 24, FIG. 27, and FIG. 29 are cross-sectional views each showing a process in the manufacturing method of the electronic component A1, and each correspond to the cross-section of the electronic component A1 shown in FIG. 11. FIG. 14, FIG. 19, FIG. 22, and FIG. 25 are bottom views each showing a process in the manufacturing method of the electronic component A1. Here, the cross-sectional views shown in FIG. 12 to FIG. 30 are turned upside down in the z-direction, from the cross-sectional views shown in FIG. 10 and FIG. 11.

The manufacturing method of the electronic component A1 includes, for example, a substrate preparation process, a coating film formation process, a first metal layer formation process, an insulation layer formation process, a penetration process, a wiring process, a second metal layer formation process, a protective film formation process, and an external electrode formation process.

Referring first to FIG. 12 and FIG. 13, the substrate 1 is prepared (substrate preparation process). The substrate 1 to be prepared is, for example, a semiconductor substrate. In this embodiment, a Si wafer is employed as the substrate 1. Here, the substrate 1 to be prepared may be a glass substrate or a ceramic substrate, instead of the semiconductor substrate. In this embodiment, a coating film 19 is then formed on the substrate 1 prepared (coating film formation process). The coating film 19 is, for example, formed of SiN. Here, the coating film 19 to be formed may include, for example, a capacitor of a MIM structure.

Proceeding to FIG. 14 to FIG. 16, the first metal layer 31 is formed on the coating film 19 (first metal layer formation process). The first metal layer formation process includes, for example, the following operation. First, a metal layer (e.g., copper) that serves as an underlying layer is formed by sputtering, all over the upper face of the coating film 19. Then a resist is formed on the underlying metal layer, and the resist is partially removed, by photolithography. Through such process, the resist is patterned. A metal plated layer is then formed, by electrolytic plating, on the region where the resist has been removed. The plated metal is, for example, copper. Thereafter, the unnecessary resist and the underlying metal layer are removed. As result, the first metal layer 31 shown in FIG. 14 to FIG. 16 is obtained.

Proceeding to FIG. 17 and FIG. 18, the insulation layer 21 is formed on the coating film 19 (insulation layer formation process). In the insulation layer formation process, for example, a dry film resist is applied to the coating film 19. The dry film resist includes an epoxy resin, serving as a photosensitive resin. As shown in FIG. 17 and FIG. 18, the insulation layer 21 covers the first metal layer 31.

Proceeding to FIG. 19 to FIG. 21, a plurality of through-holes 821 are formed through the insulation layer 21 (penetration process). In the penetration process, for example, the insulation layer 21 (dry film resist) is exposed and developed, so that the insulation layer 21 is patterned. As result, the plurality of through-holes 821 are formed. The plurality of through-holes 821 are formed on the regions where the through-wiring 33 and a part of each of the pair of connection wirings 51 and 52 are to be formed.

Proceeding to FIG. 22 to FIG. 24, the through-wiring 33 is formed in each of the plurality of through-holes 821 (wiring process). In the wiring process, copper plating is performed so as to fill in the plurality of through-holes 821. To perform the copper platin, for example, a seed layer is formed, by sputtering or vapor deposition, on the upper face of the insulation layer 21 where the plurality of through-holes 821 are formed, and a mask having a predetermined pattern is formed. Thereafter, copper is plated by electrolytic plating using the seed layer. The seed layer has a layer structure including, for example, a titanium layer and a copper layer. After the electrolytic plating, the unnecessary mask and the unnecessary seed layer. Here, the copper plating method is not limited to the above. As result, the through-wiring 33, and a part of each of the pair of connection wirings 51 and 52 are formed.

Proceeding to FIG. 25 to FIG. 27, the second metal layer 32 is formed on the insulation layer 21 (second metal layer formation process). The second metal layer formation process includes, for example, the following operations like the first metal layer formation process. First, a metal layer that serves as an underlying layer is formed by sputtering, over the entirety of the upper face of the insulation layer 21. Then a resist is formed on the underlying metal layer, and the resist is partially removed, by photolithography. A metal plated layer is then formed, by electrolytic plating, on the region where the resist has been removed. The plated metal is, for example, copper. Thereafter, unnecessary portions of the resist and the underlying metal layer are removed. As result, the second metal layer 32 shown in FIG. 25 to FIG. 27 is obtained.

Proceeding to FIG. 28 and FIG. 29, the protective film 22 is formed on the insulation layer 21 (protective film formation process). In the protective film formation process, for example, polyimide is applied to the upper face of the insulation layer 21. As shown in FIG. 28 and FIG. 29, the protective film 22 covers the second metal layer 32.

Proceeding to FIG. 30, the protective film 22 is partially removed. To remove the protective film 22, for example, a resist patterned by photolithography is formed, and then the protective film 22 exposed from the resist is removed, for example by etching. Thereafter, unnecessary portions of the resist are removed.

Then the pair of external electrodes 41 and 42 are formed (external electrode formation process). In the external electrode formation process, a metal conductor is formed on the regions where the protective film 22 has been removed, and the regions indicated by imaginary lines in FIG. 30. As result, the pair of connection wirings 51 and 52 are completed, and the pair of external electrodes 41 and 42 are formed. Here, the portion of the conductor penetrating through the protective film 22, and the pair of external electrodes 41 and 42 may be formed in separate processes. Through the mentioned process, the electronic component A1 shown in FIG. 1 to FIG. 11 can be obtained.

The electronic component A1, and the manufacturing method thereof according to the first embodiment, provide the following advantageous effects.

The foregoing manufacturing method of the electronic component A1 includes the insulation layer formation process for forming the insulation layer 21, the penetration process for forming the through-holes 821 penetrating through the insulation layer 21, and the wiring process for forming the through-wiring 33 in each of the through-holes 821. Such a manufacturing method enables formation of the coil unit 3 that is three-dimensionally wound. Accordingly, for example, at least a part of the coil unit 3 wound in the solenoid form can be formed of the through-wiring 33. The coil wound in the solenoid form contributes to suppressing an increase in component size in a plan view, due to an increase in number of turns, compared with a planarly wound coil. Therefore, the manufacturing method of the electronic component A1 enables the inductor to attain an improved Q-value, without incurring an increase in component size in a plan view, compared with the case where the coil unit 3 is planarly wound.

In the electronic component A1, the coil unit 3 is wound in the solenoid form. With such a configuration, a higher self-resonance frequency can be attained, compared with the case where the coil unit 3 is planarly wound. In other words, the manufacturing method of the electronic component A1 provides an inductor having an improved self-resonance frequency. The inductor exhibits inductive characteristics (that the impedance increases with an increase in frequency) until the self-resonance frequency is reached. However, in the range beyond the self-resonance frequency, the inductor exhibits capacitive characteristics (that the impedance decreases with an increase in frequency), owing to an impact of parasitic capacitance. This means that the inductor no longer acts as an inductor, in the frequency range higher than the self-resonance frequency. Accordingly, with the higher self-resonance frequency, the electronic component A1 can be used in a high-frequency circuit (e.g., 20 GHz or higher). Thus, the manufacturing method of the electronic component A1 provides an inductor that can be used even in a high-frequency circuit.

In the manufacturing method of the electronic component A1, the dry film resist is applied in the insulation layer formation process, and the through-holes 821 are formed in the dry film resist, in the penetration process. Then the through-wiring 33 is formed by electrolytic plating, in the wiring process. The mentioned arrangement facilitates the height (size in the z-direction) of the through-wiring 33 to be secured at an appropriate level, thereby enabling each of the loop portions 30 to be wound such that the winding axis (axial line ax1) extends in the x-direction. Therefore, the manufacturing method of the electronic component A1 allows the coil unit 3, three-dimensionally wound in the solenoid form, to be easily manufactured. Further, since the wiring resistance of the coil unit 3 is reduced, with an increase in height of the through-wiring 33, the Q-value of the coil unit 3 can be improved.

In the electronic component A1, two of the loop portions 30, adjacent to each other in the x-direction, each include a portion deviated from each other when viewed in the x-direction. With such a configuration, the interline capacitance between these loop portions 30 can be reduced, compared with the case where the two loop portions 30 completely overlap with each other. The reduction in interline capacitance leads to reduced parasitic capacitance of the coil unit 3, which contributes to improving the self-resonance frequency. Thus, the electronic component A1 can reduce the parasitic capacitance of the coil unit 3, thereby improving the self-resonance frequency. In other words, the manufacturing method of the electronic component A1 enables the inductor with an improved self-resonance frequency to be manufactured. In a simulation performed on the electronic component A1, for example, the inductance of the electronic component A1 was 0.93 nH, and the self-resonance frequency was 42 GHz. Such simulated values can be adjusted as appropriate, depending on the size of the constituents of the electronic component A1, and the number of loop portions 30.

In the electronic component A1, three of the loop portions 30, adjacent to each other in the x-direction, each include a portion deviated from each other when viewed in the x-direction. With such a configuration, the parasitic capacitance of the coil unit 3 can be further suppressed, and the self-resonance frequency can be further improved. Thus, the manufacturing method of the electronic component A1 enables the inductor with an improved self-resonance frequency to be manufactured.

In the electronic component A1, the substrate 1 is the silicon substrate. Accordingly, for example a capacitor of the MIM structure can be formed on the substrate 1 (e.g., coating film 19). Therefore, the electronic component A1 can be configured as an LC composite device. In other words, the manufacturing method of the electronic component A1 facilitates the inductor having an added value such as the LC composite device.

Hereunder, other embodiments and variations thereof of the electronic component according to the present disclosure will be described. The configurations of the parts in each of the embodiments and the variations can be combined with each other, unless technical contradiction arises.

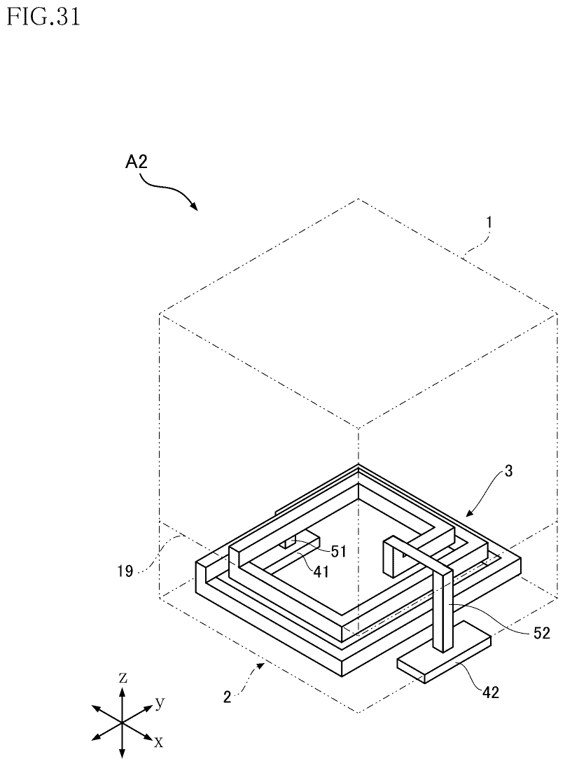

FIG. 31 to FIG. 34 illustrate an electronic component A2 according to a second embodiment. The electronic component A2 is different from the electronic component A1, in the following aspects. In the electronic component A2, as shown in FIG. 31 to FIG. 34, the loop portions 30 are formed in a rectangular ring shape, in a plan view. In this case, the axial line, corresponding to the winding axis of the loop portions 30, extends along the z-direction.

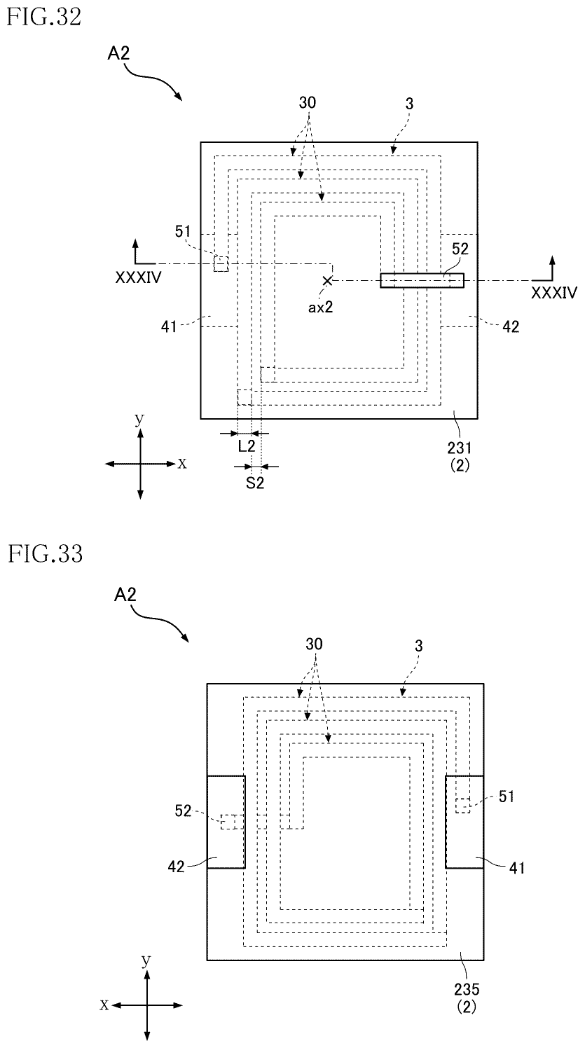

In the electronic component A2, the plurality of loop portions 30 are aligned along the z-direction. In addition, the plurality of loop portions 30 are each wound about the winding axis coinciding with a common axial line ax2 (see FIG. 32). As described above, the common axial line ax2 extends along the z-direction. Accordingly, in the case of the electronic component A2, the z-direction exemplifies the “first direction” in the present disclosure. In this embodiment, the winding axis of each of the loop portions 30 corresponds to a straight line passing through the center of a region defined by each of the loop portions 30, in a view in the z-direction.

As shown in FIG. 31 to FIG. 34, the plurality of loop portions 30 are formed such that the length in the circumferential direction becomes shorter, in the direction toward one side (upper side) in the z-direction. In a plan view, the wiring width L2 (see FIG. 32) of each of the plurality of loop portions 30 is, for example, between 8 μm and 20 μm, both ends inclusive, and the clearance S2 (see FIG. 32) between the loop portions 30 adjacent to each other is, for example, between 8 μm and 20 μm, both ends inclusive. The plurality of loop portions 30 are, as shown in FIG. 31 to FIG. 34, formed such that, in all the pairs of loop portions 30 adjacent to each other in the z-direction, an end portion of the upper loop portion 30 in the z-direction overlaps with an end portion of the lower loop portion 30 in the z-direction, in a plan view. The remaining portions are deviated from each other, in a plan view.

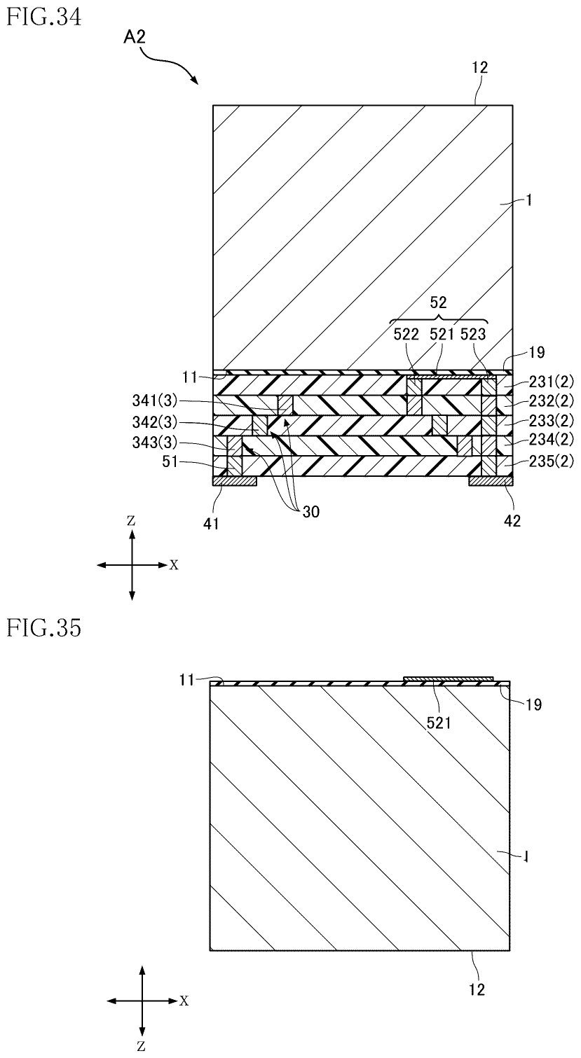

As shown in FIG. 34, the sealing member 2 of the electronic component A2 includes a plurality of insulation layers 231 to 235. Although the sealing member 2 includes five insulation layers 231 to 235 in the illustrated example, the number of the insulation layers is not limited to the above. The plurality of insulation layers 231 to 235 are stacked on each other in the z-direction. In this embodiment, the plurality of insulation layers 231 to 235 are stacked in this order, from the upper side toward the lower side, in the z-direction. Accordingly, the insulation layer 231 is in contact with the coating film 19 in the z-direction, and the insulation layer 235 is in contact with the pair of external electrodes 41 and 42, in the z-direction. The insulation layers 231 to 235 are, for example, formed of the dry film resist, like the insulation layer 21. The thickness (size in the z-direction) of each of the plurality of insulation layers 231 to 235 is, for example, between 20 μm and 45 μm, both ends inclusive. The size of the plurality of insulation layers 231 to 235 in the z-direction may differ from each other, instead of being the same.

In the electronic component A2, the coil unit 3 includes a plurality of through-wirings 341 to 343. As shown in FIG. 34, the plurality of through-wirings 341 to 343 are each formed so as to penetrate through the corresponding one of the plurality of insulation layers 232 to 234, in the z-direction. The plurality of through-wirings 341 to 343 are each wound in a rectangular ring shape, in a plan view. The two through-wirings 341 and 342 are continuous with each other, and the two through-wirings 342 and 343 are continuous with each other. With such a configuration, each of the plurality of through-wirings 341 to 343 constitutes one loop portion 30, in the coil unit 3.

The connection wiring 51 of the electronic component A2 connects the through-wiring 343 and the external electrode 41. The connection wiring 51 is penetrating through the insulation layer 235, in the z-direction. The connection wiring 51 is in contact with the end portion of the through-wiring 343, on the opposite side of the end portion continuous with the through-wiring 342.

The connection wiring 52 of the electronic component A2 connects the through-wiring 341 and the external electrode 42. The connection wiring 52 includes a first wiring section 521, a second wiring section 522, and a third wiring section 523. The first wiring section 521, the second wiring section 522, and the third wiring section 523 are electrically continuous with each other.

The first wiring section 521 is formed so as to cover a part of the coating film 19. In the illustrated example, the first wiring section 521 is not penetrating all the way through the insulation layer 231, in the z-direction. In other words, the size of the first wiring section 521 in the z-direction is smaller than the size of the through-wirings 341 to 343 in the z-direction. Instead, the first wiring section 521 may be formed so as to penetrate all the way through the insulation layer 231, in the z-direction. In other words, the first wiring section 521 may be formed in the same size in the z-direction, as that of the through-wirings 341 to 343.

The second wiring section 522 is in contact with the first wiring section 521 and the through-wiring 341. The second wiring section 522 is penetrating through the insulation layer 231 in the z-direction.

The third wiring section 523 is in contact with the first wiring section 521 and the external electrode 42. The third wiring section 523 is penetrating through the sealing member 2, in the z-direction.

In the electronic component A2, the size of the substrate 1 and the sealing member 2 in the x-direction is, for example, between 0.1 mm and 3.0 mm, both ends inclusive, and the size of the substrate 1 and the sealing member 2 in the y-direction is, for example, between 0.1 mm and 3.0 mm, both ends inclusive.

Referring now to FIG. 35 to FIG. 45, the manufacturing method of the electronic component A2 will be described hereunder. FIG. 35 to FIG. 45 are cross-sectional views each showing a process in the manufacturing method of the electronic component A2, and correspond to the cross-section of the electronic component A2 shown in FIG. 34. Here, the cross-sectional views shown in FIG. 35 to FIG. 45 are turned upside down in the z-direction, from the cross-sectional view shown in FIG. 34.

In the manufacturing method of the electronic component A2, as shown in FIG. 35, first the substrate 1 is prepared, and the coating film 19 is formed over the substrate main face 11 of the substrate 1, as in the manufacturing method of the electronic component A1.

Then the first wiring section 521 is formed on the coating film 19, as shown in FIG. 35. In the process of forming the first wiring section 521, first, a metal layer (e.g., copper or aluminum) that serves as the underlying layer is formed by sputtering, all over the upper face of the coating film 19. Then the metal layer to serve as the underlying layer is patterned by photolithography. As result, the first wiring section 521 is formed.

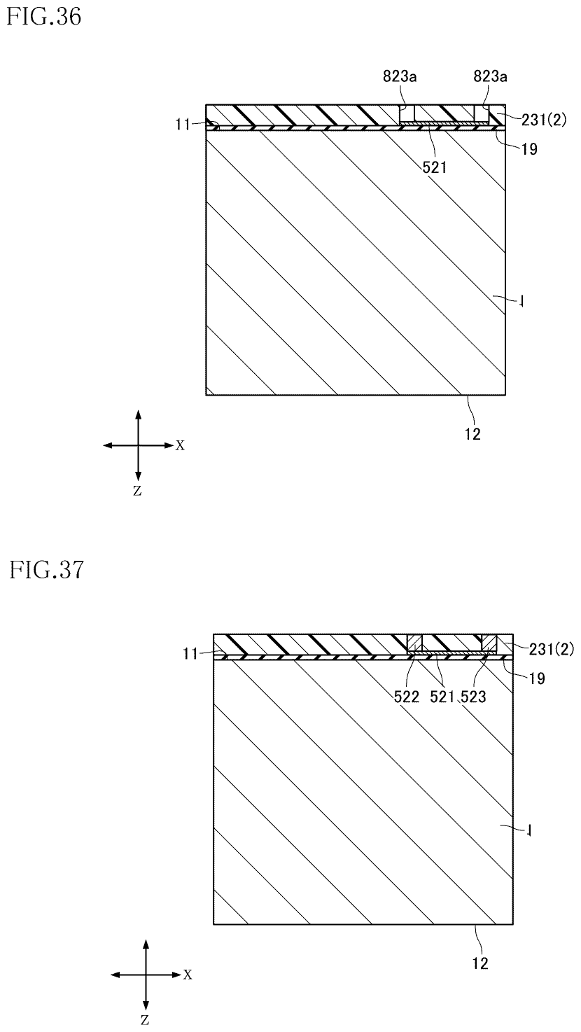

Then the insulation layer 231 is formed on the coating film 19 so as to cover the first wiring section 521, as shown in FIG. 36. To form the insulation layer 231, for example, a dry film resist is applied, as in the mentioned insulation layer formation process. Thereafter, the plurality of through-holes 823a are formed in the insulation layer 231, as shown in FIG. 36. To form the plurality of through-holes 823a, the insulation layer 231 is exposed and developed, as in the foregoing penetration process. The plurality of through-holes 823a are formed in the region where the second wiring section 522 and a part of the third wiring section 523 are to be formed.

Here, the second wiring section 522 and a part of the third wiring section 523 (portion penetrating through the insulation layer 231) are formed as shown in FIG. 37, by filling the plurality of through-holes 823a with a metal plating. The metal plating may be performed, for example, in the same way as the foregoing wiring process.

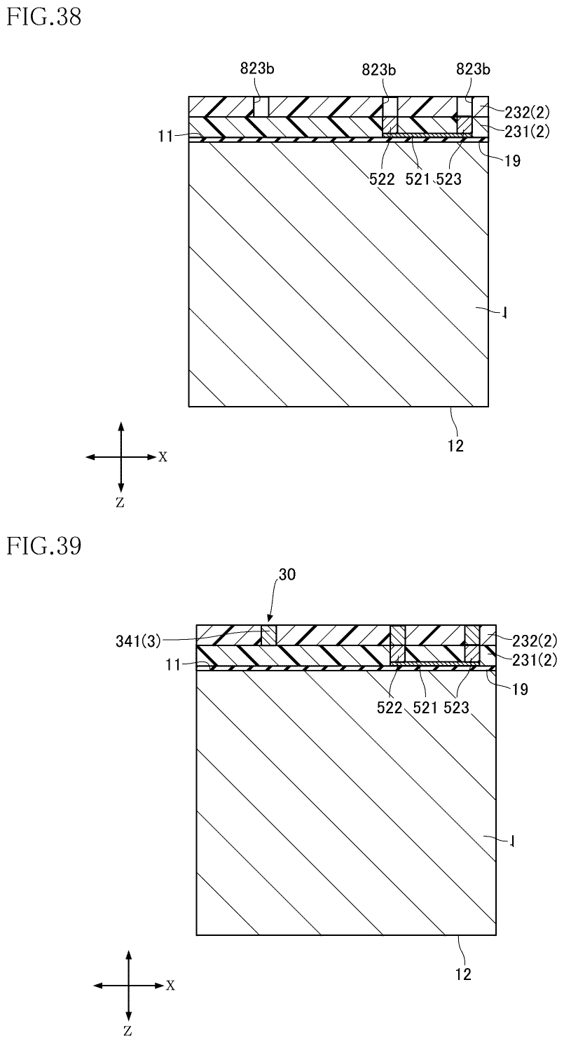

Then, after the formation of the insulation layer 232, and the formation of the plurality of through-holes 823b in the insulation layer 232 shown in FIG. 38, the through-wiring 341 and a part of the third wiring section 523 (portion penetrating through the insulation layer 232) are formed, as shown in FIG. 39. To form the insulation layer 232, a dry film resist is applied, as in the case of the insulation layer 231. To form the plurality of through-holes 823b, the insulation layer 232 is exposed and developed, as in the formation process of the plurality of through-holes 823a. The through-wiring 341 and a part of the third wiring section 523 are formed in the same way as the formation of the second wiring section 522 and a part of the third wiring section 523.

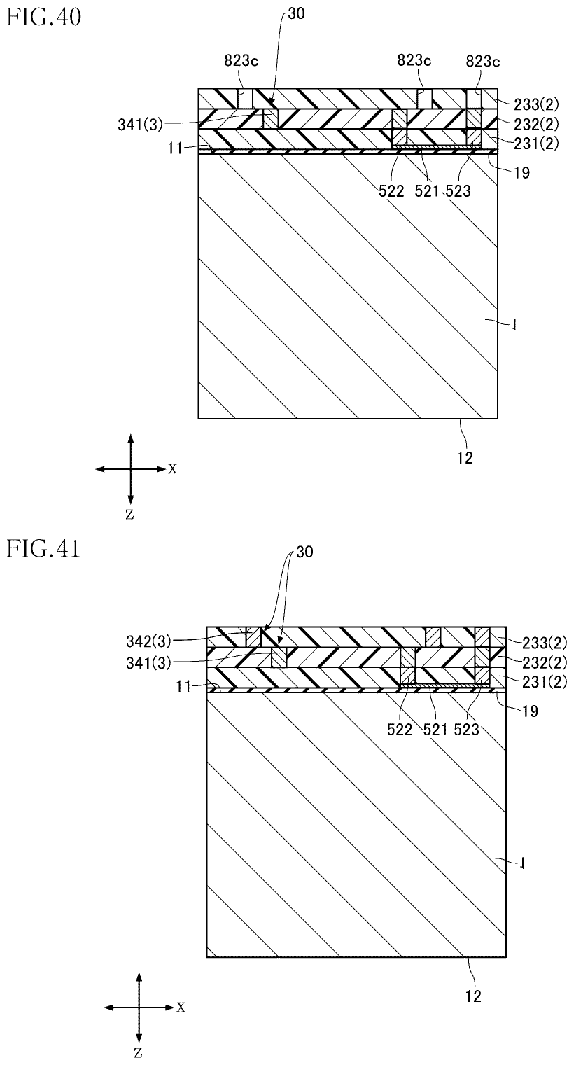

After the formation of the insulation layer 233, and the formation of the plurality of through-holes 823c in the insulation layer 233 shown in FIG. 40, the through-wiring 342 and a part of the third wiring section 523 (portion penetrating through the insulation layer 233) are formed, as shown in FIG. 41.

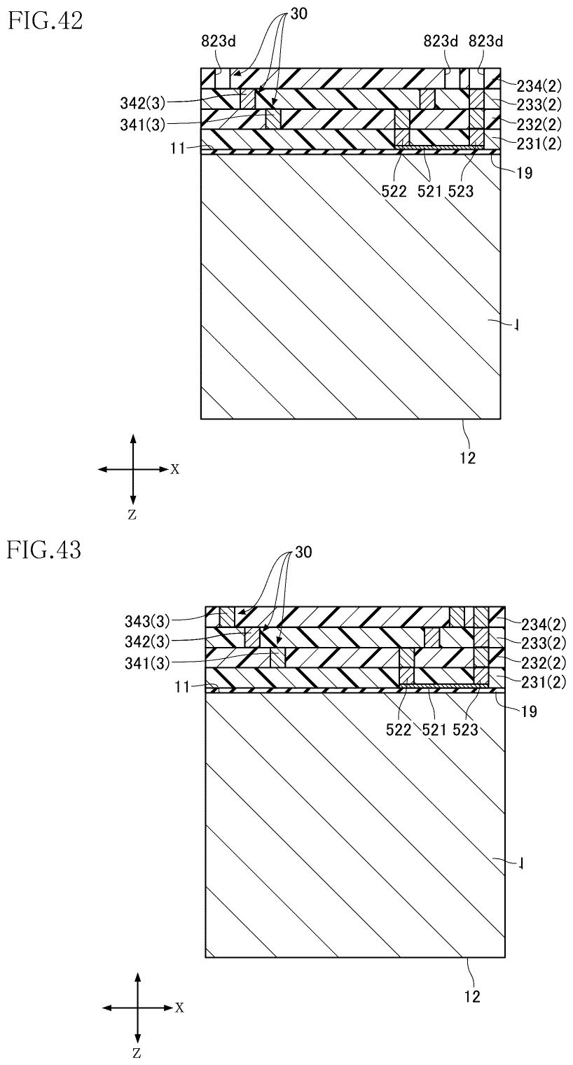

Then, after the formation of the insulation layer 234, and the formation of the plurality of through-holes 823d in the insulation layer 234 shown in FIG. 42, the through-wiring 343 and a part of the third wiring section 523 (portion penetrating through the insulation layer 234) are formed, as shown in FIG. 43.

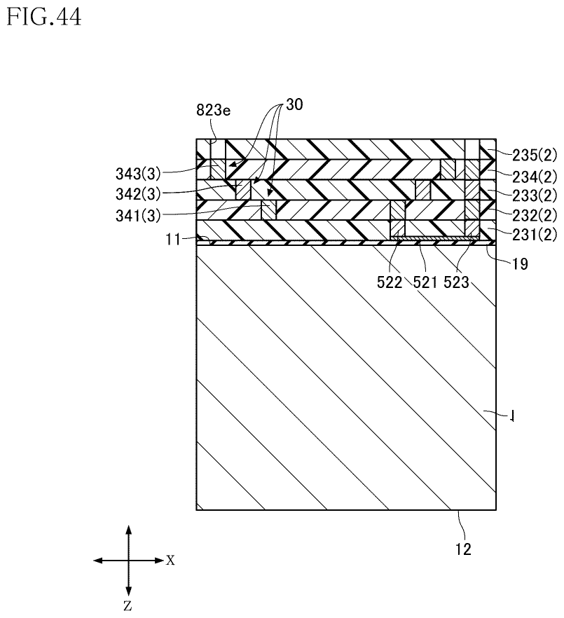

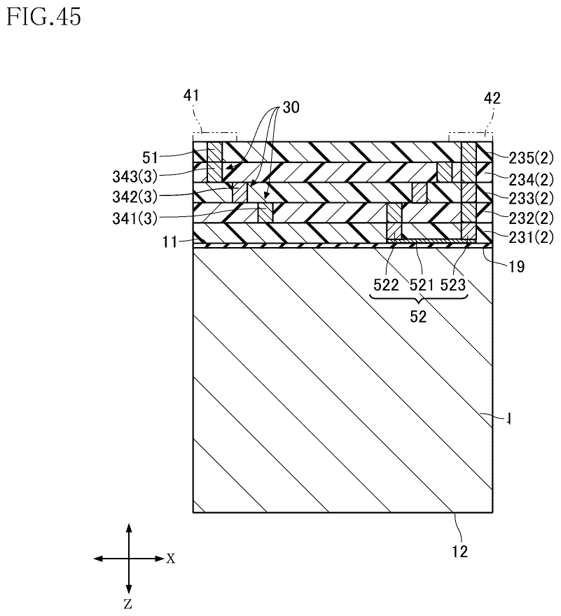

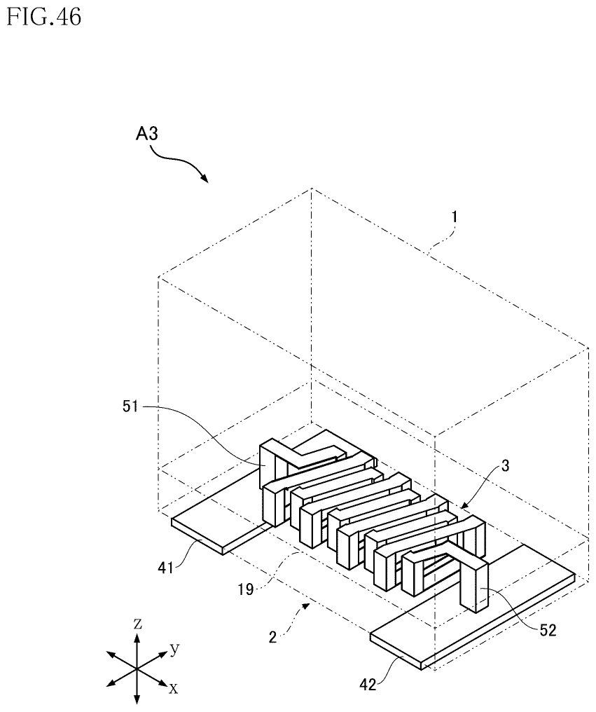

Then, after the formation of the insulation layer 235, and the formation of the plurality of through-holes 823e in the insulation layer 235 shown in FIG. 44, the connection wiring 51 and a part of the third wiring section 523 (portion penetrating through the insulation layer 235) are formed, as shown in FIG. 45. The insulation layers 233 to 235 are each formed in the same way as the formation of the insulation layer 232. The through-holes 823c to 823e are each formed in the same way as the formation of the through-holes 823b. The through-wirings 342 and 343, the connection wiring 51, and each part of the third wiring section 523 are formed in the same way as the formation of the second wiring section 522 and a part of the third wiring section 523 (portion penetrating through the insulation layer 232).

Thereafter, upon forming the pair of external electrodes 41 and 42 on the region indicated by imaginary lines in FIG. 45, the electronic component A2 is obtained. Here, instead of the mentioned manufacturing method, the connection wiring 51 and a part of the third wiring section 523 (portion penetrating through the insulation layer 235), and the pair of external electrodes 41 and 42 may be collectively formed at a time.

In the electronic component A2 also, the coil unit 3 includes the through-wirings 341, 342, and 343, and is wound in the solenoid form, like the electronic component A1. Accordingly, the manufacturing method of the electronic component A2 also provides the coil unit 3 that is three-dimensionally wound, as does the manufacturing method of the electronic component A1, and therefore, for example, at least a part of the coil unit 3 wound in the solenoid form can be formed of the through-wirings 341, 342, and 343. Therefore, the manufacturing method of the electronic component A2 enables the inductor to attain an improved Q-value, without incurring an increase in component size in a plan view, compared with the case where the coil unit 3 is planarly wound.

In addition, the configurations of the electronic component A2 that are common to those of the electronic component A1 provide the same advantageous effects as those provided by the electronic component A1. For example, in the electronic component A2, the two of the loop portions 30, adjacent to each other in the z-direction, each include a portion deviated from each other, when viewed in the z-direction. With such a configuration, the interline capacitance between these loop portions 30 can be reduced, compared with the case where the two loop portions 30 completely overlap with each other. Accordingly, the electronic component A2 can reduce the parasitic capacitance of the coil unit 3, thereby improving the self-resonance frequency. In other words, the manufacturing method of the electronic component A2 enables the inductor with an improved self-resonance frequency to be manufactured. In a simulation performed on the electronic component A2, for example, the inductance of the electronic component A2 was 1.36 nH, and the self-resonance frequency was 24 GHZ. Such simulated values can be adjusted as appropriate, depending on the size of the constituents of the electronic component A2, and the number of loop portions 30.

While the plurality of loop portions 30 of the electronic component A2 are formed such that the length in the circumferential direction becomes shorter, in the direction toward one side (upper side) in the z-direction, the loop portions 30 may be formed, for example, as follows. On the contrary, the plurality of loop portions 30 may be formed such that the length in the circumferential direction becomes shorter, in the direction toward the other side (lower side) in the z-direction. Alternatively, the odd-numbered loop portions 30 counted from the other side to the one side in the z-direction may be formed in the same circumferential length, and the even-numbered loop portions 30 may be formed in the same circumferential length. In this case, the odd-numbered loop portions 30 overlap with each other when viewed in the z-direction, and the even-numbered loop portions 30 overlap with each other, when viewed in the z-direction.

While the plurality of through-wirings 341 to 343 in the electronic component A2 are respectively formed in the plurality of insulation layers 232 to 234 sequentially stacked in the z-direction, a different configuration may be adopted. For example, an additional insulation layer may be formed between the two insulation layers 232 and 233. In this case, an additional through-wiring may further be formed so as to penetrate through the additional insulation layer, so that the additional through-wiring electrically connects the two through-wirings 341 and 342. This also applies to the two insulation layers 233 and 234.

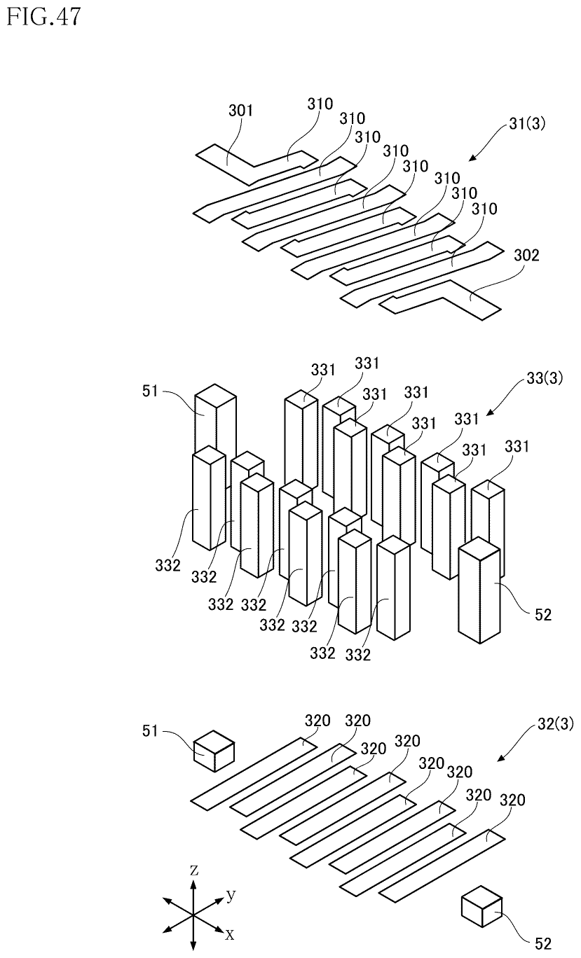

FIG. 46 to FIG. 49 illustrate an electronic component A3 according to a third embodiment. The electronic component A3 is different from the electronic component A1, in the configuration of the coil unit 3. To be more specific, in the electronic component A3, the coil unit 3 is formed such that, in all the sets of three loop portions 30 successively aligned in the x-direction, two of the three loop portions 30 on the respective sides in the x-direction overlap with each other, when viewed in the x-direction. In other words, in the electronic component A3, the odd-numbered loop portions 30 counted from the other side to the one side in the x-direction overlap with each other when viewed in the x-direction, and the even-numbered loop portions 30 overlap with each other when viewed in the x-direction. For the sake of convenience in description about the electronic component A3, the odd-numbered loop portions 30, counted in the x-direction as from the loop portion 30 continuous with the terminal portion 301, will hereinafter be referred to as “loop portions 30A”, and the even-numbered loop portions 30 will be referred to as “loop portions 30B”.

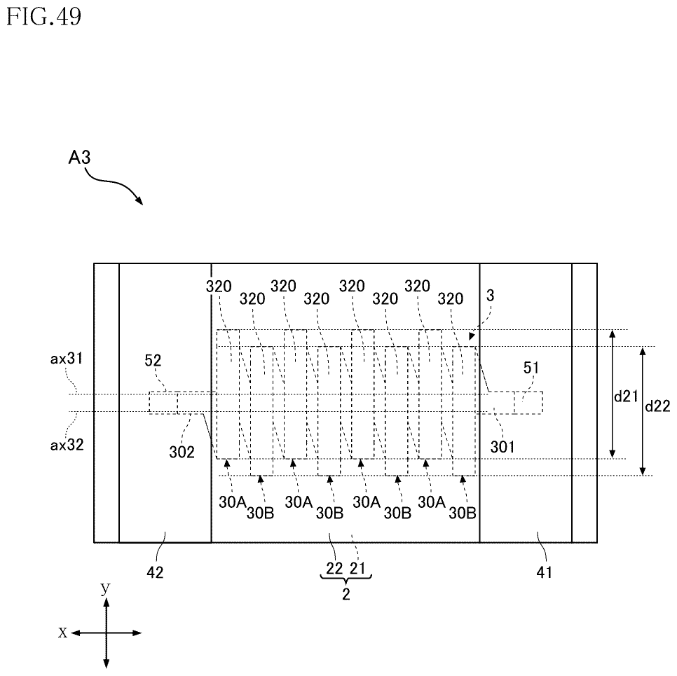

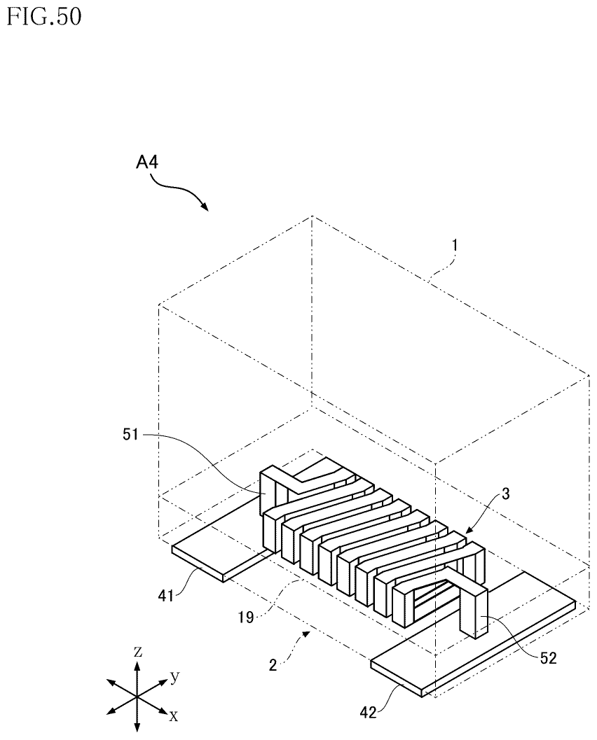

In the electronic component A3, an axial line ax31 (see FIG. 49) corresponding to the winding axis of the loop portions 30A, and an axial line ax32 (see FIG. 49) corresponding to the winding axis of the loop portions 30B, each extend along the x-direction. Accordingly, with respect to the electronic component A3, the x-direction exemplifies the “first direction” in the present disclosure, as in the case of the electronic component A1. In addition, in the electronic component A3, the axial line ax31 (see FIG. 49) corresponding to the winding axis of the loop portions 30A, and the axial line ax32 (see FIG. 49) corresponding to the winding axis of the loop portions 30B are deviated from each other, when viewed in the x-direction.

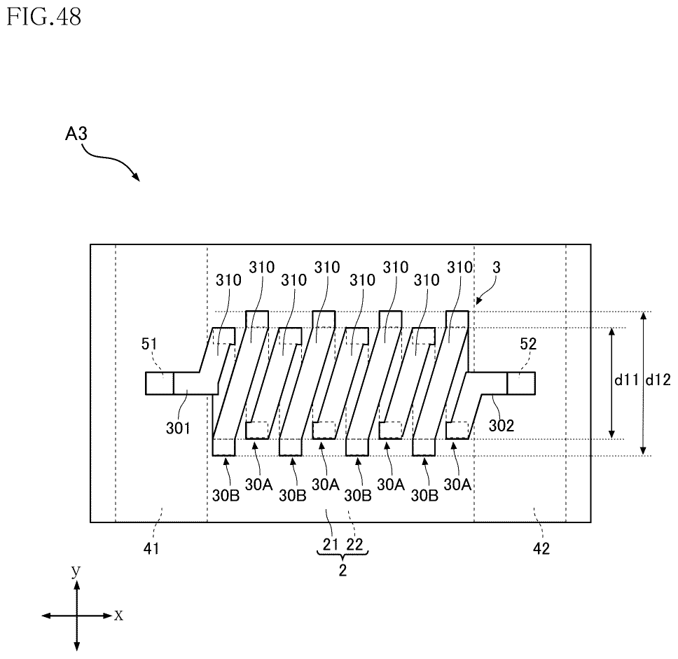

The plurality of loop portions 30A and the plurality of loop portions 30B each include one each of the belt-like portion 310, the belt-like portion 320 and the pair of penetrating portions 331 and 332. The size d11 in the y-direction (see FIG. 48) of the belt-like portion 310 of the loop portions 30A, is smaller than the size d12 in the y-direction (see FIG. 48) of the belt-like portion 310 of the loop portions 30B. On the other hand, the size d21 in the y-direction (see FIG. 49) of the belt-like portion 320 of the loop portions 30A, and the size d22 in the y-direction (see FIG. 49) of the belt-like portion 320 of the loop portions 30B are the same. In this case, the circumferential length of each of the plurality of loop portions 30A, and the circumferential length of each of the plurality of loop portions 30B are the same, or generally the same. Instead, the circumferential length of each of the plurality of loop portions 30A, and the circumferential length of each of the plurality of loop portions 30B may differ from each other.

The manufacturing method of the electronic component A3 is different from the manufacturing method of the electronic component A1, only in that the first metal layer 31, the second metal layer 32, and the through-wiring 33 are formed at different positions. In other words, the electronic component A3 can be manufactured in a similar way to the manufacturing method of the electronic component A1.

In the electronic component A3 also, the coil unit 3 includes the through-wiring 33, and is wound in the solenoid form, like the electronic component A1. Accordingly, the manufacturing method of the electronic component A3 also provides the coil unit 3 that is three-dimensionally wound, as does the manufacturing method of the electronic component A1, and therefore, for example, at least a part of the coil unit 3 wound in the solenoid form can be formed of the through-wiring 33. Therefore, the manufacturing method of the electronic component A3 enables the inductor to attain an improved Q-value, without incurring an increase in component size in a plan view, compared with the case where the coil unit 3 is planarly wound.

In addition, the configurations of the electronic component A3 that are common to those of the electronic components A1 and A2 provide the same advantageous effects. For example, in the electronic component A3, the two of the loop portions 30, adjacent to each other in the x-direction, each include a portion deviated from each other, when viewed in the x-direction, as in the electronic component A1. Accordingly, like the electronic component A1, the electronic component A3 can reduce the parasitic capacitance of the coil unit 3, thereby improving the self-resonance frequency. In other words, the manufacturing method of the electronic component A3 enables the inductor with an improved self-resonance frequency to be manufactured. In a simulation performed on the electronic component A3, for example, the inductance of the electronic component A3 was 1.12 nH, and the self-resonance frequency was 44 GHZ. Such simulated values can be adjusted as appropriate, depending on the size of the constituents of the electronic component A3, and the number of loop portions 30.

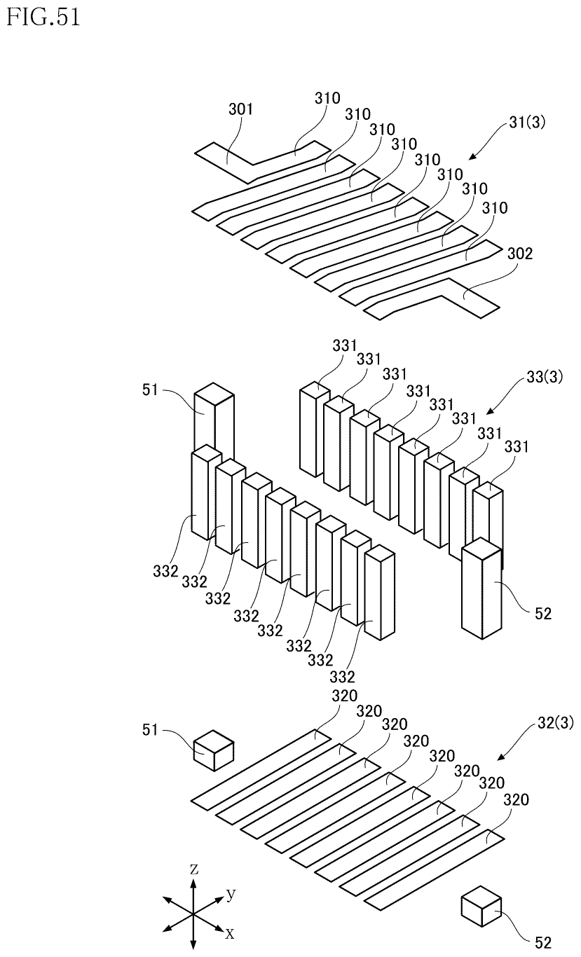

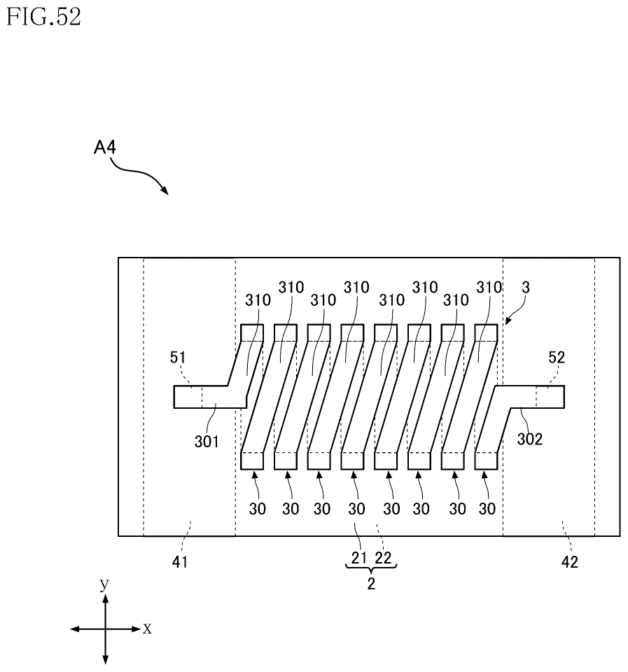

FIG. 50 to FIG. 53 illustrate an electronic component A4 according to a fourth embodiment. The electronic component A4 is different from the electronic component A1, in the configuration of the coil unit 3. To be more specific, in the electronic component A4, the coil unit 3 is formed such that, in all the pairs of loop portions 30 adjacent to each other in the x-direction, such pair of loop portions 30 overlap with each other, when viewed in the x-direction.

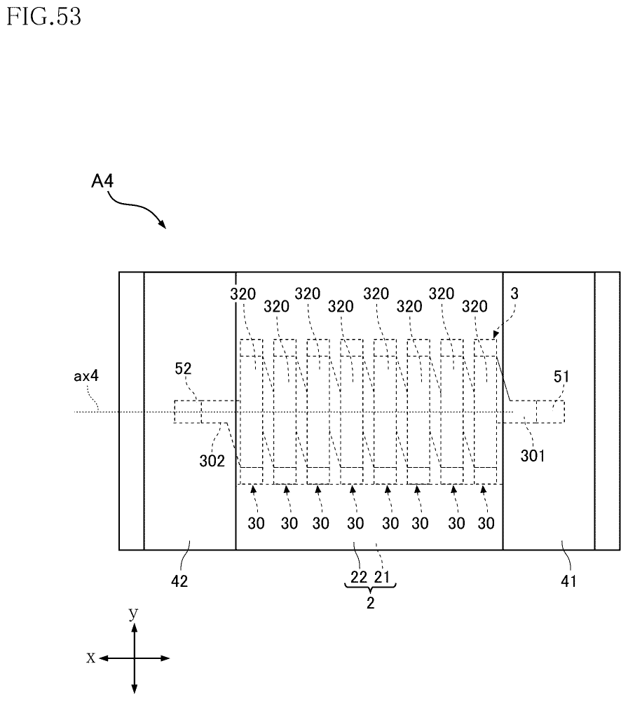

In the electronic component A4, the plurality of loop portions 30 are aligned along the x-direction, as in the electronic component A1. In addition, the plurality of loop portions 30 are wound about the winding axis coinciding with the common axial line ax4 (see FIG. 53). The axial line ax4 (see FIG. 53) extends along the x-direction. Accordingly, with respect to the electronic component A4, the x-direction exemplifies the “first direction” in the present disclosure. In addition, the axial lines, in other words the winding axes of the respective loop portions 30 coincide with each other, when viewed in the x-direction. In this embodiment, the winding axis of each of the loop portions 30 corresponds to a straight line passing through the center of the region defined by each of the loop portions 30, in a view in the x-direction. The loop portions 30 each have a rectangular ring shape centered by the axial line ax4, when viewed in the x-direction.

As shown in FIG. 52, the plurality of belt-like portions 310 of the electronic component A4 all have the same size in the y-direction. In addition, as shown in FIG. 53, the plurality of belt-like portions 320 of the electronic component A4 all have the same size in the y-direction.

The manufacturing method of the electronic component A4 is different from the manufacturing method of the electronic component A1, only in that the first metal layer 31, the second metal layer 32, and the through-wiring 33 are formed at different positions. In other words, the electronic component A4 can be manufactured in a similar way to the manufacturing method of the electronic component A1.

In the electronic component A4 also, the coil unit 3 includes the through-wiring 33, and is wound in the solenoid form, like the electronic component A1. Accordingly, the manufacturing method of the electronic component A3 also provides the coil unit 3 that is three-dimensionally wound, as does the manufacturing method of the electronic component A1, and therefore, for example, at least a part of the coil unit 3 wound in the solenoid form can be formed of the through-wiring 33. Therefore, the manufacturing method of the electronic component A4 enables the inductor to attain an improved Q-value, without incurring an increase in component size in a plan view, compared with the case where the coil unit 3 is planarly wound.

In addition, the configurations of the electronic component A4 that are common to those of the electronic components A1 to A3 provide the same advantageous effects. For example, the coil unit 3 of the electronic component A4 is wound in the solenoid form, like the coil unit 3 of the electronic component A1. Therefore, like the electronic component A1, the electronic component A4 can improve the self-resonance frequency, compared with the case where the coil unit 3 is planarly wound. In other words, the manufacturing method of the electronic component A4 enables the inductor with an improved self-resonance frequency to be manufactured. In a simulation performed on the electronic component A4, for example, the inductance of the electronic component A3 was 1.2 nH, and the self-resonance frequency was 37 GHz. Such simulated values can be adjusted as appropriate, depending on the size of the constituents of the electronic component A4, and the number of loop portions 30.

The electronic component and the manufacturing method thereof according to the present disclosure are not limited to the foregoing embodiments. The specific configuration of the electronic component, and the specific steps of the manufacturing method of the electronic component according to the present disclosure may be modified in various manners. The present disclosure encompasses the embodiments that can be defined as the following clauses.

### Clause 1.

A method for manufacturing an electronic component, the method including:
a substrate preparation process including preparing an insulative substrate;
an insulation layer formation process including forming an insulation layer on the substrate;
a penetration process including forming a through-hole penetrating through the insulation layer; and
a wiring process forming a through-wiring in the through-hole,
in which the through-wiring constitutes at least a part of a coil unit wound in a solenoid form.

### Clause 2.

The method according to clause 1, further including a first metal layer formation process, including forming a first metal layer on the substrate, before the insulation layer formation process,
in which the through-wiring is continuous with the first metal layer, and
the coil unit includes the first metal layer.

### Clause 3.

The method according to clause 2, further including a second metal layer formation process, including forming a second metal layer on the insulation layer, after the wiring process,
in which the second metal layer is continuous the through-wiring, and
the coil unit includes the second metal layer.

### Clause 4.

The method according to clause 3,
in which the coil unit includes a first loop portion and a second loop portion continuous with each other,
a first axial line corresponding to a winding axis of the first loop portion, and a second axial line corresponding to a winding axis of the second loop portion each extend along a first direction, orthogonal to a thickness direction of the insulation layer, and
the first loop portion and the second loop portion are formed of the first metal layer, the second metal layer, and the through-wiring.

### Clause 5.

The method according to clause 4,
in which the first axial line and the second axial line coincide with each other.

### Clause 6.

The method according to clause 1,
in which the insulation layer includes a first insulation layer and a second insulation layer stacked in a thickness direction, and
the insulation layer formation process includes forming the first insulation layer on the substrate, and forming the second insulation layer on the first insulation layer.

### Clause 7.

The method according to clause 6,
in which the penetration process includes forming a first through-hole in the first insulation layer, and forming a second through-hole in the second insulation layer, and
the wiring process includes forming a first through-wiring in the first through-hole, and forming a second through-wiring in the second through-hole.

### Clause 8.

The method according to clause 7,
in which the coil unit includes a first loop portion formed of the first through-wiring, and a second loop portion formed of the second through-wiring, and
a first axial line corresponding to a winding axis of the first loop portion, and a second axial line corresponding to a winding axis of the second loop portion, each extend along the thickness direction.

### Clause 9.

The method according to any one of clause 1 to clause 8,
in which the insulation layer is formed of a dry film resist.

### Clause 10.

The method according to clause 9,
in which the wiring process includes forming the through-wiring by electrolytic plating.

### Clause 11.

The method according to any one of clause 1 to clause 10,
in which the substrate includes a silicon substrate.

### Clause 12.

The method according to any one of clause 1 to clause 11, further including a protective film formation process, including forming a protective film on an opposite side of the substrate in a thickness direction of the insulation layer.

### Clause 13.

The method according to clause 12,
in which the protective film includes polyimide.

### Clause 14.

The method according to clause 12 or clause 13, further including an external electrode formation process, including forming, on the protective film, an external electrode electrically continuous with the coil unit.

### Clause 15.

The method according to any one of clause 1 to clause 14, further including, after the substrate preparation process and before the insulation layer formation process, a coating film formation process including forming a coating film,
in which the substrate includes a main face opposed to the insulation layer,
the coating film covers the main face, and
the coil unit is formed on the coating film.

### REFERENCE NUMERALS

A1 to A4: electronic component
1: substrate
2: sealing member
3: coil unit
11: substrate main face
12: substrate back face
19: coating film
21: insulation layer
22: protective film
30, 30A, 30B: loop portion
31: first metal layer
32: second metal layer
33: through-wiring
41, 42: external electrode
51 and 52: connection wiring
231 to 235: insulation layer
301: end portion
302: end portion
310: belt-like portion
320: belt-like portion
331: penetrating portion
332: penetrating portion
341, 342, 343: through-wiring
521: first wiring section
522: second wiring section
523: third wiring section
821, 823a to 823e: through-hole
ax1, ax2, ax31, ax32, ax4: axial line

1. A method for manufacturing an electronic component, the method comprising:
a substrate preparation process including preparing an insulative substrate;
an insulation layer formation process including forming an insulation layer on the substrate;
a penetration process including forming a through-hole penetrating through the insulation layer; and
a wiring process forming a through-wiring in the through-hole,
wherein the through-wiring constitutes at least a part of a coil unit wound in a solenoid form.

2. The method according to claim 1, further comprising a first metal layer formation process, including forming a first metal layer on the substrate, before the insulation layer formation process,
wherein the through-wiring is continuous with the first metal layer, and
the coil unit includes the first metal layer.

3. The method according to claim 2, further comprising a second metal layer formation process, including forming a second metal layer on the insulation layer, after the wiring process,
wherein the second metal layer is continuous the through-wiring, and
the coil unit includes the second metal layer.

4. The method according to claim 3,
wherein the coil unit includes a first loop portion and a second loop portion continuous with each other,
a first axial line corresponding to a winding axis of the first loop portion, and a second axial line corresponding to a winding axis of the second loop portion each extend along a first direction, orthogonal to a thickness direction of the insulation layer, and
the first loop portion and the second loop portion are formed of the first metal layer, the second metal layer, and the through-wiring.

5. The method according to claim 4,
wherein the first axial line and the second axial line coincide with each other.

6. The method according to claim 1,
wherein the insulation layer includes a first insulation layer and a second insulation layer stacked in a thickness direction, and
the insulation layer formation process includes forming the first insulation layer on the substrate, and forming the second insulation layer on the first insulation layer.

7. The method according to claim 6,
wherein the penetration process includes forming a first through-hole in the first insulation layer, and forming a second through-hole in the second insulation layer, and
the wiring process includes forming a first through-wiring in the first through-hole, and forming a second through-wiring in the second through-hole.

8. The method according to claim 7,
wherein the coil unit includes a first loop portion formed of the first through-wiring, and a second loop portion formed of the second through-wiring, and
a first axial line corresponding to a winding axis of the first loop portion, and a second axial line corresponding to a winding axis of the second loop portion, each extend along the thickness direction.

9. The method according to claim 1,
wherein the insulation layer is formed of a dry film resist.

10. The method according to claim 9,
wherein the wiring process includes forming the through-wiring by electrolytic plating.

11. The method according to claim 1,
wherein the substrate includes a silicon substrate.

12. The method according to claim 1, further comprising a protective film formation process, including forming a protective film on an opposite side of the substrate in a thickness direction of the insulation layer.

13. The method according to claim 12,
wherein the protective film includes polyimide.

14. The method according to claim 12, further comprising an external electrode formation process, including forming, on the protective film, an external electrode electrically continuous with the coil unit.

15. The method according to claim 1, further comprising, after the substrate preparation process and before the insulation layer formation process, a coating film formation process including forming a coating film,
wherein the substrate includes a main face opposed to the insulation layer,
the coating film covers the main face, and
the coil unit is formed on the coating film.
